(19) United States
(12) Patent Application Publication
(10) Pub. No.: US 2014/0274659 A1
(43) Pub. Date: Sep. 18, 2014

(54) METHODS, MATERIALS, AND APPARATUSES ASSOCIATED WITH ADSORBING HYDROCARBON GAS MIXTURES

(71) Applicant: OSCOMP SYSTEMS INC., Houston, TX (US)

(72) Inventors: Jimmy ROMANOS, Houston, TX (US); Pedro T. SANTOS, Houston, TX (US); Scott RACKEY, Bedford, MA (US)

(73) Assignee: OSCOMP SYSTEMS INC., Houston, TX (US)

(21) Appl. No.: 14/213,510

(22) Filed: Mar. 14, 2014

Related U.S. Application Data
(60) Provisional application No. 61/787,503, filed on Mar. 15, 2013.

(51) Int. Cl. B01J 20/34; B01J 20/20; B01J 20/28; B01J 20/30

(52) U.S. Cl. CPC B01J 20/3491; B01J 20/3085; B01J 20/20; B01J 20/305; B01J 20/3458; B01J 20/3078; B01J 20/28042
USPC 502/5; 502/418; 502/416; 502/437; 502/423; 502/401; 502/427; 502/34; 502/56; 502/20; 502/400; 502/407

(57) ABSTRACT

Adsorbed natural gas (ANG) technology is an energy efficient approach for storing NG at room temperature and low pressure. ANG technology can be applied to several aspects of the NG industry. The usage of an adsorbent material in natural gas storage and transport may provide increased storage density of NG at a given pressure and decreased pressure of gaseous fuel at a given gas density. Such adsorbent materials have been shown to store substantial quantities of natural gas at relatively modest pressures. Because lower-pressure vessels can be far less expensive than comparable sized high-pressure vessels, ANG based storage can be used to lower the cost of storing natural gas in various applications.

### CROSS-REFERENCE

This application claims the benefit of priority from U.S. Provisional Application No. 61/787,503, filed Mar. 15, 2013, titled “Methods, Materials, And Apparatuses Associated With Adsorbing Hydrocarbon Gas Mixtures,” the entire contents of which are hereby incorporated by reference herein.

### FIELD OF THE DISCLOSURE

This disclosure relates to methods, materials, and apparatuses associated with adsorbing hydrocarbon gas mixtures.

### BACKGROUND

Natural gas (NG) is a naturally occurring hydrocarbon gas mixture comprising primarily of methane, with other hydrocarbons, carbon dioxide, nitrogen and hydrogen sulfide. Natural gas is an energy source often used for heating, cooking, and electricity generation. It is also used as fuel for vehicles and as a chemical feedstock in the manufacture of plastics and other commercially important organic chemicals.

NG currently provides about 23% of the world's energy. The proven reserves of NG are increasing with new detection and extraction technologies. For example, hydraulic fracturing, which is currently used in the extraction of NG from shale rock formations, is having a dramatic impact on world energy supply. The Energy Information Administration estimates the United States possesses 2543 trillion cubic feet of technically recoverable natural gas in the United States. Methane hydrate reservoirs, found under sediments on the ocean floors, contain two to ten times the currently known reserves of NG. The high price of gasoline may allow NG to play an important role in shaping the energy industry in the years and decades to come. NG is a strong candidate for the auto and energy industry.

Compressed natural gas (CNG) and liquefied natural gas (LNG) are currently established technologies for the storage and transport of NG. Both of these technologies, however, have drawbacks including the costs associated with compression or liquefaction as well as the containers necessary to store CNG or LNG.

### SUMMARY

One aspect of the disclosure relates to a method for producing an adsorbent material configured to adsorb hydrocarbon gas mixtures. The method comprises: obtaining an activated carbon material having a first surface area per weight and/or volume; and performing a second stage activation process on the activated carbon material such that the activated carbon develops a second surface area per weight (e.g., m²/g) and/or volume (e.g., m²/cm²), the second surface area per weight and/or volume being greater than the first surface area per weight and/or volume. This aspect includes an adsorbent material configured to adsorb hydrocarbon gas mixtures, the adsorbent material being prepared by a process comprising the aforementioned steps.

Another aspect of the disclosure relates to a method for producing an adsorbent material from a lignocellulose material, the adsorbent material being configured to adsorb hydrocarbon gas mixtures. The method comprises: obtaining the lignocellulose material; and producing the adsorbent material by performing an activation process on the lignocellulose material such that the lignocellulose material develops a surface area per weight and/or volume suitable for adsorbing hydrocarbon gas mixtures, the activation process including quantitatively selecting pore volumes by controlling carbon consumption and intercalation into a carbon lattice of the lignocellulose material. This aspect includes an adsorbent material configured to adsorb hydrocarbon gas mixtures, the adsorbent material being prepared by a process comprising the aforementioned steps.

Another aspect of the disclosure relates to a method for producing an adsorbent material from a carbon-based nanomaterial, the adsorbent material being configured to adsorb hydrocarbon gas mixtures. The method comprises: obtaining a carbon-based nanomaterial; and producing the adsorbent material by performing an activation process on the carbon-based nanomaterial such that the carbon-based nanomaterial develops a surface area per weight and/or volume suitable for adsorbing hydrocarbon gas mixtures. This aspect includes an adsorbent material configured to adsorb hydrocarbon gas mixtures, the adsorbent material being prepared by a process comprising the aforementioned steps.

Another aspect of the disclosure relates to a method for producing an adsorbent material from a carbonaceous material, the adsorbent material being configured to adsorb hydrocarbon gas mixtures. The method comprises: obtaining a carbonaceous material; and producing the adsorbent material by performing an activation process on the carbonaceous material such that the carbonaceous material develops a surface area per weight and/or volume suitable for adsorbing hydrocarbon gas mixtures. This aspect includes an adsorbent material configured to adsorb hydrocarbon gas mixtures, the adsorbent material being prepared by a process comprising the aforementioned steps.

Another aspect of the disclosure relates to a method for producing an adsorbent material from a polymer material, the adsorbent material being configured to adsorb hydrocarbon gas mixtures. The method comprises: obtaining the polymer material; and producing the adsorbent material by performing an activation process on the polymer material such that the polymer material develops a surface area per weight and/or volume suitable for adsorbing hydrocarbon gas mixtures. This aspect includes an adsorbent material configured to adsorb hydrocarbon gas mixtures, the adsorbent material being prepared by a process comprising the aforementioned steps.

Another aspect of the disclosure relates to a method for activating carbon-based material using ultraviolet-induced ozone etching or plasma etching to produce an adsorbent material configured to adsorb hydrocarbon gas mixtures. The method comprises: providing molecular oxygen proximate to surfaces of the carbon-based material; and irradiating the carbon-based material with ultraviolet light of a first wavelength to effectuate dissociation of the molecular oxygen to atomic oxygen, the atomic oxygen reacting with carbon atoms in the carbon-based material, the reaction between the atomic oxygen and the carbon atoms causing the carbon atoms to be removed from the carbon-based material to create or enhance porosity in the carbon-based material such that the porous carbon-based material is an adsorbent material configured to adsorb hydrocarbon gas mixtures. This aspect includes an adsorbent material configured to adsorb hydrocarbon gas mixtures, the adsorbent material being prepared by a process comprising the aforementioned steps.

Another aspect of the disclosure relates to a method for activating carbon-based material using controlled oxidation to produce an adsorbent material configured to adsorb hydrocarbon gas mixtures. The method comprises: exposing the carbon-based material to a sequence of high-temperature loading cycles; and degassing oxygen during the loading cycles to avoid ignition and burning of the carbon-based material. This aspect includes an adsorbent material configured to adsorb hydrocarbon gas mixtures, the adsorbent material being prepared by a process comprising the aforementioned steps.

Another aspect of the disclosure relates to a method for enhancing surfaces of an adsorbent material configured to adsorb hydrocarbon gas mixtures. The method comprises introducing one or more non-carbon elements to surfaces of the adsorbent material to increase a binding energy between methane molecules and the surfaces of the adsorbent material. This aspect includes an adsorbent material having enhanced surfaces and configured to adsorb hydrocarbon gas mixtures, the adsorbent material being prepared by a process comprising the aforementioned step.

Another aspect of the disclosure relates to a method for forming hydrates in pores of an adsorbent material configured to adsorb hydrocarbon gas mixtures. The method comprises introducing methane and water to pores of the adsorbent material to effectuate formation of methane hydrate within the pores. This aspect includes an adsorbent material configured to adsorb hydrocarbon gas mixtures, the adsorbent material being prepared by a process comprising the aforementioned step.

Another aspect of the disclosure relates to a method for tuning pore volume in a carbon-based adsorbent material. The method comprises: adjusting a concentration of an activation agent used to produce or enhance the adsorbent material, the activation agent including potassium hydroxide; and adjusting an activation temperature; wherein a volume of supra-nanometer pores in the adsorbent material is proportional to (1) the activation temperature and (2) a weight ratio between the potassium hydroxide and carbon.

Another aspect of the disclosure relates to a method for regenerating an adsorbent material from natural gas contaminants configured to adsorb hydrocarbon gas mixtures. The method comprises: removing contaminants from the adsorbent material by performing one or more of: exposing the adsorbent material to a vacuum; exposing the adsorbent material to an elevated temperature; flowing a hot gas through the adsorbent material; or flowing a cold gas through the adsorbent material.

Another aspect of the disclosure relates to a method for producing an adsorbent material monolith configured to adsorb hydrocarbon gas mixtures. The method comprises: obtaining an adsorbent material in a loose form comprising one or more of a powder, grains, sands, or pellets; obtaining a loose-form sorbent-binder mixture by interspersing the loose-form adsorbent material with a binding material in a loose form comprising one or more of a powder, grains, sands, or pellets; compressing the loose-form sorbent-binder mixture to form a green body; and heating the green body to pyrolyze the binder material to produce the adsorbent material monolith.

One or more aspects of the disclosure provide a method for producing an adsorbent material configured to adsorb hydrocarbon gas mixtures, the method comprising: obtaining an activated carbon material having a first surface area per weight and/or volume; and performing a second stage activation process on the activated carbon material such that the activated carbon develops a second surface area per weight and/or volume, the second surface area per weight and/or volume being greater than the first surface area per weight and/or volume.

According to one or more aspects of the disclosure, the first surface area per weight and/or volume is less than about 1200 square meters per gram.

According to one or more aspects of the disclosure, the second surface area per weight and/or volume is greater than about 3000 square meters per gram.

According to one or more aspects of the disclosure, the second surface area is more than double the first surface area per weight and/or volume.

According to one or more aspects of the disclosure, the second stage activation process includes a controlled oxidation.

According to one or more aspects of the disclosure, the second stage activation process includes a combination of two or more of a chemical activation, a physical activation, a controlled oxidation, ultraviolet-ozone etching, plasma etching, or a carbonization.

According to one or more aspects of the disclosure, the method includes performing a third stage activation process on the activated carbon material such that the activated carbon develops a third surface area per weight and/or volume, the third surface area per weight and/or volume being greater than the second surface area per weight and/or volume.

According to one or more aspects of the disclosure, the method includes recycling an activation agent used in the second state activation process for use in a later activation process.

One or more aspects of the disclosure provide a method for producing an adsorbent material from a lignocellulose material, the adsorbent material being configured to adsorb hydrocarbon gas mixtures, the method comprising: obtaining the lignocellulose material; and producing the adsorbent material by performing an activation process on the lignocellulose material such that the lignocellulose material develops a surface area per weight and/or volume suitable for adsorbing hydrocarbon gas mixtures, the activation process including quantitatively selecting pore volumes by controlling carbon consumption and intercalation into a carbon lattice of the lignocellulose material.

According to one or more aspects of the disclosure, the lignocellulose material includes one or more of corncob material or coconut shell material.

According to one or more aspects of the disclosure, the method includes recycling an activation agent used in the activation process for use in a later activation process.

One or more aspects of the disclosure provide a method for producing an adsorbent material from a carbon-based nanomaterial, the adsorbent material being configured to adsorb hydrocarbon gas mixtures, the method comprising: obtaining a carbon-based nanomaterial; and producing the adsorbent material by performing an activation process on the carbon-based nanomaterial such that the carbon-based nanomaterial develops a surface area per weight and/or volume suitable for adsorbing hydrocarbon gas mixtures.

According to one or more aspects of the disclosure, the carbon-based nanomaterial includes one or more of fullerenes, nanohorns, or graphene.

According to one or more aspects of the disclosure, the activation process includes one or more of a chemical activation, a physical activation, a controlled oxidation, or a carbonization.

One or more aspects of the disclosure provide a method for producing an adsorbent material from a carbonaceous material, the adsorbent material being configured to adsorb hydrocarbon gas mixtures, the method comprising: obtaining a carbonaceous material; and producing the adsorbent material by performing an activation process on the carbonaceous material such that the carbonaceous material develops a surface area per weight and/or volume suitable for adsorbing hydrocarbon gas mixtures.

According to one or more aspects of the disclosure, the carbonaceous material includes one or more of carbon blacks, surface enhanced flake graphite, nanographite, expandable flake graphite, or pitch coke.

According to one or more aspects of the disclosure, the activation process includes one or more of a chemical activation, a physical activation, a controlled oxidation, or a carbonization.

According to one or more aspects of the disclosure, the activation process includes quantitatively selecting pore volumes by controlling carbon consumption and intercalation into a carbon lattice of the carbonaceous material.

One or more aspects of the disclosure provide a method for producing an adsorbent material from a polymer material, the adsorbent material being configured to adsorb hydrocarbon gas mixtures, the method comprising: obtaining the polymer material; and producing the adsorbent material by performing an activation process on the polymer material such that the polymer material develops a surface area per weight and/or volume suitable for adsorbing hydrocarbon gas mixtures.

According to one or more aspects of the disclosure, the polymer material includes one or both of polyvinylidene chloride or polyvinyl alcohol.

According to one or more aspects of the disclosure, the activation process includes one or more of a chemical activation, a physical activation, a controlled oxidation, or a carbonization.

According to one or more aspects of the disclosure, the activation process includes quantitatively selecting pore volumes by controlling carbon consumption and intercalation into a carbon lattice of the lignocellulose material.

According to one or more aspects of the disclosure, the method includes performing a second stage activation process on adsorbent material such that the adsorbent material develops an increased surface area per weight and/or volume.

One or more aspects of the disclosure provide a method for activating carbon-based material using ultraviolet-induced ozone etching to produce an adsorbent material configured to adsorb hydrocarbon gas mixtures, the method comprising: providing molecular oxygen proximate to surfaces of the carbon-based material; and irradiating the carbon-based material with ultraviolet light of a first wavelength to effectuate dissociation of the molecular oxygen to atomic oxygen, the atomic oxygen reacting with carbon atoms in the carbon-based material, the reaction between the atomic oxygen and the carbon atoms causing the carbon atoms to be removed from the carbon-based material to create or enhance porosity in the carbon-based material such that the porous carbon-based material is an adsorbent material configured to adsorb hydrocarbon gas mixtures.

According to one or more aspects of the disclosure, providing the molecular oxygen proximate to the surfaces of the carbon-based material includes irradiating the carbon-based material with ultraviolet light of a second wavelength to effectuate generation of ozone as the molecular oxygen.

According to one or more aspects of the disclosure, the second wavelength is about 185 nanometers.

According to one or more aspects of the disclosure, one or both of surface area per weight and/or volume or pore volume is controlled by one or more of irradiation time associated with the ultraviolet light of a first wavelength, irradiation time associated with the ultraviolet light of a second wavelength, oxygen concentration proximate to the carbon-based material, or an ambient temperature proximate to the carbon-based material.

According to one or more aspects of the disclosure, the first wavelength is about 254 nanometers.

According to one or more aspects of the disclosure, providing the molecular oxygen proximate to the surfaces of the carbon-based material includes one or both of chemisorbing or physisorbing the molecular oxygen to the surfaces of the carbon-based material.

According to one or more aspects of the disclosure, providing the molecular oxygen proximate to the surfaces of the carbon-based material includes subjecting the carbon-based material to oxygen plasma etching.

According to one or more aspects of the disclosure, one or more steps are performed at about room temperature.

According to one or more aspects of the disclosure, the carbon-based material includes one or both of a carbonaceous material or a lignocellulose material.

According to one or more aspects of the disclosure, the carbon-based material includes an activated carbon material.

One or more aspects of the disclosure provide a method for activating carbon-based material using controlled oxidation to produce an adsorbent material configured to adsorb hydrocarbon gas mixtures, the method comprising: exposing the carbon-based material to a sequence of high-temperature loading cycles; and degassing oxygen during the loading cycles to avoid ignition and burning of the carbon-based material.

According to one or more aspects of the disclosure, the high-temperature loading cycles reach or exceed about 600 degrees Celsius.

One or more aspects of the disclosure provide a method for enhancing surfaces of an adsorbent material configured to adsorb hydrocarbon gas mixtures, the method comprising: introducing one or more non-carbon elements to surfaces of the adsorbent material to increase a binding energy between methane molecules and the surfaces of the adsorbent material.

According to one or more aspects of the disclosure, the one or more non-carbon elements include one or more of iron, lithium, magnesium, chromium, aluminum, sodium, or boron.

One or more aspects of the disclosure provide a method for forming hydrates in pores of an adsorbent material configured to adsorb hydrocarbon gas mixtures, the method comprising: introducing methane and water to pores of the adsorbent material to effectuate formation of methane hydrate within the pores.

According to one or more aspects of the disclosure, the water is introduced as water vapor prior to introducing the methane.

According to one or more aspects of the disclosure, the water is introduced as water vapor contemporaneously with the introduction of the methane.

According to one or more aspects of the disclosure, the methane is introduced prior to the water, the water being introduced as water vapor.

One or more aspects of the disclosure provide a method for tuning pore volume in a carbon-based adsorbent material, the method comprising: adjusting a concentration of an activation agent used to produce or enhance the adsorbent material, the activation agent including potassium hydroxide; and adjusting an activation temperature. A volume of supra-nanometer pores in the adsorbent material is proportional to (1) the activation temperature and (2) a weight ratio between the potassium hydroxide and carbon.

According to one or more aspects of the disclosure, the method includes adjusting one or more of a pre-activation treatment, an activation method, an activation agent, a mixing procedure, an activation container, homogenization, an activation time, a heating rate, a cooling rate, an activation atmosphere, a gas flow rate, an inlet gas temperature, a washing procedure, or a post-activation treatment.

One or more aspects of the disclosure provide a method for regenerating an adsorbent material configured to adsorb hydrocarbon gas mixtures, the method comprising removing contaminants from the adsorbent material by performing one or more of: exposing the adsorbent material to a vacuum; exposing the adsorbent material to an elevated temperature; flowing a hot gas through the adsorbent material; or flowing a cold gas through the adsorbent material.

One or more aspects of the disclosure provide a method for producing an adsorbent material monolith configured to adsorb hydrocarbon gas mixtures, the method comprising: obtaining an adsorbent material in a loose form comprising one or more of a powder, grains, sands, or pellets; obtaining a loose-form sorbent-binder mixture by interspersing the loose-form adsorbent material with a binding material in a loose form comprising one or more of a powder, grains, sands, or pellets; compressing the loose-form sorbent-binder mixture to form a green body; and heating the green body to pyrolyze the binder material to produce the adsorbent material monolith.

According to one or more aspects of the disclosure, the loose-form sorbent-binder mixture is compressed under vacuum.

According to one or more aspects of the disclosure, the method includes filling pores in the green body with gas or liquid prior to pyrolyzation.

According to one or more aspects of the disclosure, the gas or liquid includes one or more of water vapor, nitrogen, methane, or hydrogen.

According to one or more aspects of the disclosure, the adsorbent material monolith is shaped as a briquette.

According to one or more aspects of the disclosure, the adsorbent material monolith is shaped so as to have one or more 90 degree edges.

According to one or more aspects of the disclosure, the loose-form adsorbent material includes differing sizes of one or more of powder, grains, sands, or pellets.

One or more aspects of the disclosure provide a method for storing hydrocarbon gas mixtures, the method comprising: at least partially filling a tank with a hydrocarbon gas mixture, the tank containing an adsorbent material configured to receive the hydrocarbon gas mixture by adsorption; at least partially emptying the hydrocarbon gas mixture from the tank by desorbing the hydrocarbon gas mixture from the adsorbent material; repeating the filling and emptying, each sequential combination of filling and emptying comprising a fill/empty cycle; and regenerating the adsorbent material to at least partially restore adsorption capabilities of the adsorbent material, wherein the regenerating cyclically occurs at least as frequently as once every 500 fill/empty cycles.

According to various aspects of the disclosure, the regenerating occurs at least as frequently as once every 400, 300, 200, 100, 90, 80, 70, 60, 50, 40, 30, 20, 15, 10, 9, 8, 7, 6, 5, 4, 3, 2, and/or 1 fill/empty cycles.

According to one or more aspects of the disclosure, the tank has a hydrocarbon gas mixture mass capacity; and the regenerating cyclically occurs at least as often as once each time that 5000 times the gas mass capacity flows out of the tank.

According to one or more aspects of the disclosure, the regenerating cyclically occurs at least as often as once each time that 10 times the gas mass capacity flows out of the tank.

According to one or more aspects of the disclosure, regenerating the adsorbent material comprises one or more of: exposing the adsorbent material to a vacuum; or exposing the adsorbent material to an elevated temperature; or exposing the adsorbent material to a purge gas.

According to one or more aspects of the disclosure, regenerating the adsorbent material comprises exposing the adsorbent material to a purge gas. The purge gas may comprise nitrogen, argon, another inert gas, or any other suitable gas.

According to one or more aspects of the disclosure, the vacuum has a pressure between 10⁻¹ torr and 10⁻⁵ torr.

According to one or more aspects of the disclosure, the elevated temperature is between 50° C. and 600° C., and may be at least 100° C.

According to one or more aspects of the disclosure, the adsorbent material is exposed to the vacuum during regeneration for a duration between 0.25 hours and 120 hours.

According to one or more aspects of the disclosure, the duration of vacuum exposure is between 0.5 and 4 hours.

According to one or more aspects of the disclosure, the adsorbent material is exposed to the elevated temperature during regeneration for a duration between 0.5 hours and 120 hours.

According to one or more aspects of the disclosure, the duration of elevated temperature exposure is between 0.5 and 4.0 hours.

One or more aspects of the disclosure provide a method for regenerating an adsorbent material configured to adsorb hydrocarbon gas mixtures in order to at least partially restore adsorption capabilities of the adsorbent material, the adsorbent material being contained within the interior volumes of two tanks, the method comprising: storing a hydrocarbon gas mixture in one of the tanks while regenerating adsorbent material contained within the other tank, the other tank being substantially empty of hydrocarbon gas mixture; and alternating the storage of the hydrocarbon gas mixture and regeneration of adsorbent material between the two tanks such at any given time at least one tank used to store the hydrocarbon gas mixture.

According to one or more aspects of the disclosure, the two tanks comprise a first tank and a second tank, and the method further comprises: at least partially filling the first tank with a hydrocarbon gas mixture, the filling generating heat; and transferring at least a portion of the heat to the second tank such that the heat aids in the regeneration of the adsorbent material in the second tank during the regeneration of the adsorbent material in the second tank.

One or more aspects of the disclosure provide a system for storing hydrocarbon gas mixtures, the system comprising: a tank having an interior volume, the tank configured to be at least partially filled with a hydrocarbon gas mixture, the interior volume of the tank containing an adsorbent material configured to receive the hydrocarbon gas mixture by adsorption, wherein the tank is configured to at least partially empty the hydrocarbon gas mixture from the tank by desorbing the hydrocarbon gas mixture from the adsorbent material, and wherein the combination of filling and emptying comprises a fill/empty cycle; and means for regenerating the adsorbent material to at least partially restore adsorption capabilities of the adsorbent material, wherein the regenerating occurs at least as frequently as once every 500 fill/empty cycles.

According to one or more aspects of the disclosure: the tank has a hydrocarbon gas mixture mass capacity; and the means for regenerating comprises a means for regenerating cyclically at least as often as once each time that 5000 times the gas mass capacity flows out of the tank.

According to one or more aspects of the disclosure, the means for regenerating comprises: a vacuum source in fluid communication with the interior volume of the tank configured to expose the adsorbent material to a vacuum; a source of purge gas in fluid communication with the interior volume of the tank configured to expose the adsorbent material to the purge gas; or a heat source in fluid communication with the interior volume of the tank configured to expose the adsorbent material to an elevated temperature.

According to one or more aspects of the disclosure, the means for regenerating comprises a vacuum source in fluid communication with the interior volume of the tank configured to expose the adsorbent material to a vacuum. The vacuum source may be a pump.

According to one or more aspects of the disclosure, the means for regenerating comprises a heat source in fluid communication with the interior volume of the tank configured to expose the adsorbent material to an elevated temperature. The heat source may be a heater.

According to one or more aspects of the disclosure, the means for regenerating comprises a source of purge gas in fluid communication with the interior volume of the tank configured to expose the adsorbent material to the purge gas.

According to one or more aspects of the disclosure: the tank comprises a first tank; the system further comprises a second tank having an interior volume containing adsorbent material configured to receive hydrocarbon gas mixtures by adsorption; the system has first and second operational modes; the first operational mode comprises a mode in which the adsorbent material in the second tank is regenerated while the first tank is used to store and supply the hydrocarbon gas mixture; and the second operational mode comprises a mode in which the adsorbent material in the first tank is regenerated while the second tank is used to store and supply the hydrocarbon gas mixture.

According to one or more aspects of the disclosure, the system includes a controller connected to the tanks, the controller being configured to selectively operate the system in the first or second operational mode.

According to one or more aspects of the disclosure, the system includes a heat transfer system that is configured such that: in the first operational mode, the heat transfer system transfers heat from the first tank to the second tank to aid in the regeneration of the adsorbent material in the second tank during the regeneration of the adsorbent material in the second tank; and in the second operational mode, the heat transfer system transfers heat from the second tank to the first tank to aid in the regeneration of the adsorbent material in the second tank during the regeneration of the adsorbent material in the second tank.

According to one or more aspects of the disclosure, an adsorbent material is configured to adsorb hydrocarbon gas mixtures, wherein the adsorbent material is prepared by any one or more of the methods discussed herein. According to one or more aspects of the disclosure, the adsorbent material has enhanced surfaces.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

All closed-ended (e.g., between A and B) and open-ended (greater than C) ranges of values disclosed herein explicitly include all ranges that fall within or nest within such ranges. For example, a disclosed range of 1-10 is understood as also disclosing, among other ranged, 2-10, 1-9, 3-9, etc.

### BRIEF DESCRIPTION OF THE DRAWINGS

FIG. 1 illustrates a method for producing an adsorbent material configured to adsorb hydrocarbon gas mixtures, in accordance with one or more embodiments.

FIG. 2 illustrates a method for producing an adsorbent material from a lignocellulose material, in accordance with one or more embodiments.

FIG. 3 illustrates a Method for producing an adsorbent material from a carbon-based nanomaterial, in accordance with one or more embodiments.

FIG. 4 illustrates a method for producing an adsorbent material from a carbonaceous material, in accordance with one or more embodiments.

FIG. 5 illustrates a method for producing an adsorbent material from a polymer material, in accordance with one or more embodiments.

FIG. 6 illustrates a method for activating carbon-based material using ultraviolet-induced ozone etching to produce an adsorbent material configured to adsorb hydrocarbon gas mixtures, in accordance with one or more implementations.

FIG. 7 illustrates a method for activating carbon-based material using controlled oxidation to produce an adsorbent material configured to adsorb hydrocarbon gas mixtures, in accordance with one or more embodiments.

FIG. 8 illustrates a method for enhancing surfaces of an adsorbent material configured to adsorb hydrocarbon gas mixtures, in accordance with one or more embodiments.

FIG. 9 illustrates a method for forming hydrates in pores of an adsorbent material configured to adsorb hydrocarbon gas mixtures, in accordance with one or more embodiments.

FIG. 10 illustrates a simple representation of the effect of pore structure on methane adsorption, in accordance with one or more embodiments.

FIG. 10B illustrates a method for tuning pore volume in a carbon-based adsorbent material, in accordance with one or more embodiments.

FIG. 11 illustrates a method for regenerating an adsorbent material configured to adsorb hydrocarbon gas mixtures, in accordance with one or more embodiments.

FIG. 12 illustrates a method for producing an adsorbent material monolith configured to adsorb hydrocarbon gas mixtures, in accordance with one or more embodiments.

FIG. 13A illustrates an exemplary sorbent-binder mixture, in accordance with one or more implementations.

FIG. 13B illustrates an exemplary compression of a sorbent-binder mixture, in accordance with one or more embodiments.

FIG. 13C illustrates an exemplary result of pyrolysis, in accordance with one or more embodiments.

FIG. 14 illustrates a system configured to compress a loose-form sorbent-binder mixture to form a green body, in accordance with one or more embodiments.

FIG. 15 illustrates an exemplary result of apollonian packing, in accordance with one or more embodiments.

FIG. 16 illustrates a system configured to fill pore in a green body with gas or liquid, in accordance with one or more embodiments.

FIG. 17 illustrates exemplary adsorbent material monoliths shaped to facilitate radial filling, in accordance with one or more embodiments.

FIG. 18 illustrates a method for activating carbon-based material to produce an adsorbent material configured to adsorb hydrocarbon gas mixtures, in accordance with one or more embodiments.

FIG. 19 illustrates parameters employed in the execution of the method of FIG. 18, in accordance with one or more embodiments.

FIG. 20 illustrates the composition of anthracite coal (AC5) used as a precursor material in accordance with one or more embodiments of the method depicted in FIG. 18.

FIG. 21 illustrates the composition of calcinated petroleum coke (CF70W) used as a precursor material in accordance with one or more embodiments of the method depicted in FIG.

FIG. 22 illustrates the composition of calcinated pitch coke (4876) used as a precursor material in accordance with one or more embodiments of the method depicted in FIG. 18.

FIG. 23 illustrates the composition of calcinated petroleum (4456) used as a precursor material in accordance with one or more embodiments of the method depicted in FIG. 18.

FIG. 24 illustrates the composition of surface enhanced flake graphite (3807) used as a precursor material in accordance with one or more embodiments of the method depicted in FIG. 18.

FIG. 25 illustrates resultant gravimetric excess adsorption employing one or more various precursor materials used in accordance with one or more embodiments of the method shown in FIG. 18, concluding that materials with relatively higher volatile, ash, and oxygen content were best suited for activation.

FIG. 26 depicts a plot of the effect of water content on gravimetric excess adsorption, in accordance with one or more embodiments.

FIG. 27 depicts a plot of the effect of mixing time on gravimetric excess adsorption, in accordance with one or more embodiments.

FIG. 28 depicts a plot of the effect of mixing temperature on gravimetric excess adsorption, in accordance with one or more embodiments.

FIG. 29 illustrates systems for evaluating effects of nitrogen flow rate on the gravimetric excess adsorption, in accordance with one or more embodiments.

FIG. 30 depicts a plot illustrating the effects of nitrogen flow rate on gravimetric excess adsorption using the systems illustrated in FIG. 29.

FIG. 31 illustrates a plot of sample measurements showing gravimetric excess adsorption of various adsorbents as a function of pressure, in accordance with one or more embodiments.

FIG. 32 illustrates a plot of sample measurements showing gravimetric storage capacity of various adsorbents as a function of pressure, in accordance with one or more embodiments.

FIG. 33 illustrates a plot of sample measurements showing volumetric storage capacity of various adsorbents as a function of pressure, in accordance with one or more embodiments.

FIG. 34 illustrates a system for regenerating an adsorbent material from natural gas contaminants configured to adsorb hydrocarbon gas mixtures.

FIG. 35 illustrates a plot of gravimetric excess adsorption for methane and natural gas as a function of cycles of regeneration through the system of FIG. 34, in accordance with one or more embodiments.

FIG. 36 shows an initial composition of natural gas prior to regeneration.

FIG. 37 illustrates a plot of gravimetric excess adsorption for natural gas as a function of cycles of regeneration, in accordance with one or more embodiments.

FIG. 38 illustrates a plot of gravimetric storage capacity for natural gas as a function of cycles of regeneration, in accordance with one or more embodiments.

FIG. 39 illustrates a plot of volumetric storage capacity for natural gas as a function of cycles of regeneration, in accordance with one or more embodiments.

FIG. 40 shows the composition of the natural gas at 100 cycles.

FIG. 41 shows the composition of the natural gas at 500 cycles.

FIG. 42 illustrates a plot of gravimetric excess adsorption for natural gas as a function of cycles of regeneration, in accordance with one or more embodiments

FIG. 43 depicts a table of investigational results of regeneration percentage associated with corresponding regeneration techniques.

FIG. 44 depicts a table of investigational results of efficiency drops associated with a corresponding regeneration technique.

FIG. 45 illustrates a method for producing an adsorbent material monolith configured to adsorb hydrocarbon gas mixtures, in accordance with one or more embodiments.

FIG. 46 illustrates parameters employed in the execution of the method of FIG. 45, in accordance with one or more embodiments.

FIG. 47 illustrates the effect of binder material on volumetric storage capacity, in accordance with one or more embodiments.

FIG. 48 illustrates the effect of precursor material on volumetric storage capacity, in accordance with one or more embodiments.

FIG. 49 illustrates the effect of binder concentration on volumetric storage capacity using PVA binder, in accordance with one or more embodiments.

FIG. 50 illustrates the effect of binder concentration on volumetric storage capacity using ENG binder, in accordance with one or more embodiments.

FIG. 51 illustrates the effect of compaction pressure on volumetric storage capacity, in accordance with one or more embodiments.

FIG. 52 illustrates a plot of sample measurement showing the effects of pressure on volumetric storage capacity, in accordance with one or more embodiments.

FIG. 53 illustrates an investigation model depicting the propagation of chilled methane filling a sorbent tank from one end, in accordance with one or more embodiments.

FIG. 54 illustrates a plot of temperature as a function of distance through a sorbent tank at various time intervals, in accordance with one or more embodiments.

FIG. 55 illustrates a plot of sorbent temperature change over time at a fixed distance in a sorbent tank, in accordance with one or more embodiments.

FIG. 56 illustrates a plot of sorbent temperature as a function of distance through the sorbent tank at various time intervals, in accordance with one or more embodiments.

FIG. 57 illustrates an investigational model depicting the propagation of chilled methane filling a sorbent tank from both ends of the sorbent tank, in accordance with one or more embodiments.

FIG. 58 illustrates a plot of temperature as a function of distance through a sorbent tank at various time intervals, in accordance with one or more embodiments.

FIG. 59 illustrates a plot of sorbent temperature as a function of distance through a sorbent tank at various time intervals, in accordance with one or more embodiments.

FIG. 60 illustrates a method for storing hydrocarbon gas mixtures, in accordance with one or more embodiments.

FIG. 61 illustrates a method for regenerating an adsorbent material configured to adsorb hydrocarbon gas mixtures in order to at least partially restore adsorption capabilities of the adsorbent material, wherein the adsorbent material is contained by an interior volume of a tank.

FIG. 62 illustrates a method for regenerating an adsorbent material configured to adsorb hydrocarbon gas mixtures in order to at least partially restore adsorption capabilities of the adsorbent material, wherein adsorbent material is contained within the interior volumes of two tanks.

FIG. 63 illustrates a single tank system for storing hydrocarbon gas mixtures including one or more regeneration techniques to at least partially restore adsorption capabilities of an adsorbent material used in the storage of the gas mixture, in accordance with one or more embodiments.

FIG. 64 illustrates a dual tank system for storing hydrocarbon gas mixtures including one or more regeneration techniques to at least partially restore adsorption capabilities of an adsorbent material used in the storage of the gas mixture, in accordance with one or more embodiments.

### DETAILED DESCRIPTION

Adsorbed natural gas (ANG) technology is an energy efficient approach for storing NG at room temperature and low pressure. ANG technology can be applied to several aspects of the NG industry. The usage of an adsorbent material in natural gas storage and transport may provide advantages including increases storage density of NG at a given pressure and decreased pressure of gaseous fuel at a given gas density. Such adsorbent materials have been shown to store substantial quantities of natural gas at relatively modest pressures. For example, in some implementations, a vessel including adsorbent can store as much mass of natural gas at a relatively low pressure (e.g., 500 PSIG) as a CNG vessel at a much higher pressure (e.g., 3600 PSIG). Because lower-pressure vessels can be far less expensive than comparable sized high-pressure vessels, ANG based storage can be used to lower the cost of storing natural gas in various applications. The low pressures (e.g., 100-250 psig, 250-750 psig) associated with ANG may facilitate use of inexpensive thin tank walls and conformable tank geometry. Furthermore, the low pressures do not require multi-stage compression.

According to various embodiments, the adsorbent may comprise a porous material. The porous material has a high surface area per weight and/or volume with a substantial adsorptive capacity. By way of non-limiting example, the adsorbent may include one or more of a metal organic framework, a covalent organic framework, nanohorns, engineered porous graphene, chemical-hydride interactions, cross-linked polymers and/or gels, and/or other porous materials. Adsorbents may include any material with a substantial adsorptive capacity including but not limited to activated carbons, metal oxide frameworks, and/or zeolites. Some adsorbents are manufactured in loose form such as powders, grains, sands or pellets. Such loose forms may be contained and handled during manufacture and operation in porous containers including but not limited to woven or non-woven fabric container (e.g., sacks) or other porous structure or material or membrane which would enable easy handling and would simultaneously act to filter any adsorbent that becomes airborne and prevent such airborne particles from traveling downstream to where they may clog or otherwise damage equipment.

Adsorbents typically exhibit the behavior wherein the adsorptive performance drops as temperature increases. Thus, a vessel including an adsorbent at a given pressure and temperature will store less gaseous fuel than it would at a lower temperature and the same pressure. Due to the heat of adsorption, vessels including adsorbent typically heat up upon filling. After the filled vessel returns to ambient temperature, its pressure will increase. To avoid this effect and achieve the maximum storage for a given pressure and ambient temperature, the gaseous fuel can be pre-cooled prior to introduction to the vessel including (one or more) adsorbents, for example, using the cooled loading techniques described in PCT Publication No. WO2014/031999, filed Aug. 23, 2013, published Feb. 27, 2014, titled “VIRTUAL GASEOUS FUEL PIPELINE,” the entire contents of which are hereby incorporated by reference herein in its entirety. With appropriate controls, the gaseous fuel may be pre-cooled sufficiently that the thermal capacity of the gaseous fuel compensates for all or part of the heat released by the heat of adsorption during filling. In some cases, the vessel including the ANG may be filled and cooled simultaneously by introducing gaseous fuel in one end and removing a fraction of the gaseous fuel from another point on the vessel, thereby flowing the gaseous fuel past the adsorbent. This can enhance the cooling effect and cause the cooling effect to be more uniform throughout the cooling vessel. The removed gaseous fuel can be suitably recompressed and re-introduced to the inlet stream. Such recirculated gaseous fuel may also be actively refrigerated to enhance the cooling effect.

The converse also happens where the vessel including ANG cools down when being emptied at the user site. This has the effect of reducing the pressure of the vessel and causing the vessel to stop emptying, when limited to minimum operating pressure. This effect can be counteracted, in whole or in part, by incorporating a method to introduce heat back into the adsorbent. This can include heat pipes, heat exchangers (passive or active), or other methods. In some cases, gaseous fuel may be recirculated through the vessel similar to the cooling recirculation described above. In some cases, such recirculated gaseous fuel may be passively heated using heat from the ambient environment or in other cases actively heated utilizing a heat exchanger in the recirculation loop. Such heat may come from any source including but not limited to a direct burner, or heat carried by a secondary working fluid that is heated by an indirect source. Such direct and indirect sources of heat may include wasted heat from the user site. PCT Publication No. WO2014/031999, incorporated herein by reference, describes various suitable techniques for introducing heat into the vessel and adsorbent during unloading. Any one or more of those techniques may be used in connection with various embodiments described herein.

ANG storage may be kept at or below ambient temperature. If ANG vessels are kept at modestly low temperature (e.g. −20° C.), their storage density can rival CNG and in some cases may approach LNG densities. As used herein, the term cryogenic means a temperature below −20° F.

In some cases, it may be desirable to actively pump gaseous fuel from a vessel including adsorbent to some other part of a system that requires a higher pressure. This has the added effect of increasing the utilization of the adsorbent including vessel by removing more gaseous fuel during the unloading cycle than otherwise would have been removed. Any pumping device capable of creating a pressure differential may be used, e.g. compressors, blowers, diaphragm pumps, turbo pumps, etc. Such pumping can be used in conjunction with heating and/or cooling described above.

Adding heat to an adsorbent filled vessel will increase the actual pressure of the vessel because hot adsorbents release gas and do not adsorb, thus leading to “adsorption compression.”

In some embodiments, a stationary ANG storage tank may be used to unload a high pressure CNG tank for stationary storage. For example, the pressure difference from a 3600 psi CNG tank to a 500 psi ANG tank may offer several advantages compared to unloading a high pressure CNG tank to an empty vessel.

In some embodiments, a stationary ANG storage tank may be used to regulate and/or control pipeline flow by storing NG during low consumption peaks and providing natural gas during high peak consumption.

Natural gas transportation for longer distances pipelines may be done at relatively high pressure pipeline (15-100 bar). At the gate station, the pressure of the gas may be reduced for distribution between 1 and 15 bar depending on the distribution system. Pressure reduction may be accomplished in throttle-valves. Most gases cool during the expansion (e.g., due to the Joule-Thompson effect). The temperature drop in natural gas is approx. 4.5-6° C. per 10 bar, depending on gas composition and state.

The heat released during tank charging (heat of adsorption plus adiabatic compression) generally leads to lower natural gas storage at the target pressure. In addition, during tank discharge, the heat of desorption may result in a considerable amount of gas retained in the tank at the depletion pressure.

Chilled gas filling can create a cold front moving from the inlet through the tank. Chilling technologies of natural gas can be employed for the removal of water from natural gas because it may need to be dried before pipeline transport (e.g., due to pipeline corrosion, flow restriction, pressure drops, and/or other considerations). Turbo-expanders and Joule-Thompson valves may be used for natural gas chilling. Similar technologies may be used in the liquefaction process of natural gas.

Solving the energy, momentum, and continuity equation with the appropriate system boundary conditions using finite element analysis and advanced modeling software, may be an appropriate approach to simulate chilled natural gas filling of sorbent tank. Solving the three dimensional system allows the determination of temperature, pressure, and gas velocity as a function or time and space.

This method may be based on several assumptions (e.g., uniform gas stream, no heat lost through the tank wall, and/or other assumptions). The coefficient of heat transfer k (cal/s·K or J/s·K) for cooling coke is the rate of heat acquisition divided by the difference between the gas stream and the solid temperature. The derivation may be expressed as:

$$k = \frac{A \cdot {u}^{0.7} {T}^{0.3} {10}^{1.68 f - 3.56 f}}{{d}^{1.3}}$$

$$z = \frac{k}{{Q}_{s} ( 1 - f )} ( t - \frac{f x}{u} )$$

$$y = \frac{k x}{{Q}_{g } u}$$

A numerical solution of the following equations may be used to determine Tₛ(x,t):

Tₛ(x,t)=T₀_{ₛ}−T₀∫₀^{z}I₀(2\sqrt{yz})·e^{-y-z}dz

where I₀(2\sqrt{yz}) is the modified Bessel function of the first kind and zeroth order.

The above equations may be characterized by the following units of measurement:

| | |
|---|---|
| k | cal/s · K |
| u (inlet flow rate of cross sectional, area) | liter/cm² · s |
| T (temperature) | ° C. |
| d (particle diameter) | cm |
| Qₛ volumetric heat capacity of sorbent | cal/cm³ · K |
| Q_{g} volumetric heat capacity of gas | cal/cm³ · K |
| x (distance from the inlet) | cm |
| t (time) | s |
| T_{g} (x, t) gas temperature at t and x | K |
| T_{g0} initial gas temperature | K |
| Tₛ (x, t) sorbent temperature at t and x | K |
| Tₛ₀ initial sorbent temperature | K |
| T₀ = \|Tₛ₀ − T_{g0}\| | K |
| f (porosity) | Percentage |
| A (constant for each substance) | |

In an investigation model depicted in FIG. 53 depicting the propagation of chilled methane into a three meter sorbent tank filling from one end, the following parameters were used:

| | |
|---|---|
| Inlet methane temperature | −30° C. |
| Expected tank temperature (heat of | 100° C. |
| adsorption and adiabatic expansion | |
| Inlet gas flow | 0.2 liter/cm²s |
| Sorbent heat capacity | 650 J/kg K |
| Methane heat capacity | 2450 J/kg K |
| Methane volumetric heat capacity | 3.66 · 10⁻⁴ cal/cm²s |
| For natural gas: A = 3.2 · Aₐᵢᵣ | .036 |
| Aₐᵢᵣ is calculated to be 0.012 for coke | |
| Porosity | 0.65 |
| Pellet average size | 1 cm |
| Sorbet volumetric heat capacity | 0.113 cal/cm³K |

Using the above noted parameters and equations, sorbent temperature as a function of distance through the model tank was evaluated as illustrated in the various plots shown in FIG. 54, FIG. 55, and FIG. 56.

FIG. 57 illustrates an investigation tank model depicting the propagation of chilled methane through both ends of a three meter sorbent tank. The results of the evaluated temperature as a function of distance through the tank are illustrated in the plots of FIG. 58 and FIG. 59.

According to various embodiments, any one or more of the cooled/chilled filing methods, structures, and systems disclosed in PCT Publication No. WO2014/031999, incorporated herein by reference, may be used to fill the tanks disclosed herein.

FIG. 1 illustrates a method 100 for producing an adsorbent material configured to adsorb hydrocarbon gas mixtures, in accordance with one or more embodiments. The steps of method 100 presented below are intended to be illustrative. In some embodiments, method 100 may be accomplished with one or more additional steps not described, and/or without one or more of the steps discussed. Additionally, the order in which the steps of method 100 are shown in FIG. 1 and described below is not intended to be limiting.

At a step 102, an activated carbon material having a first surface area per weight and/or volume is obtained. This may include an existing low-cost activated carbon having a moderate surface area (e.g., <1200 m2/g) and lower methane uptake.

At a step 104, a second stage activation process is performed on the activated carbon material such that the activated carbon develops a second surface area per weight and/or volume. The second surface area per weight and/or volume is greater than the first surface area per weight and/or volume. The second surface area may be more than double the first surface area per weight and/or volume. According to some embodiments, the first surface area per weight and/or volume is less than about 1200 square meters per gram, and/or the second surface area per weight and/or volume is greater than about 3000 square meters per gram.

The second stage activation process may include various steps. In some embodiments, the second stage activation process includes a controlled oxidation, which is described further herein. In some embodiments, the second stage activation process includes a combination of two or more of a chemical activation, a physical activation, a controlled oxidation, a carbonization, ultraviolet-ozone etching, plasma etching, and/or other processes. Chemical activation may involve KOH, H₃PO₄, ZnCl₂, NAOH, and/or other compounds. Physical activation may involve CO₂, H₂0 (vapor), and/or other compounds.

At a step 106, a third stage activation process may be performed on the activated carbon material such that the activated carbon develops a third surface area per weight and/or volume. The third surface area per weight and/or volume is greater than the second surface area per weight and/or volume. The third stage activation process may include one or more steps and/or processes described in connection with the second stage activation process.

At a step 108, an activation agent used in the second (and/or third) stage activation process is recycled for use in a later activation process.

FIG. 2 illustrates a method 200 for producing an adsorbent material from a lignocellulose material, in accordance with one or more embodiments. The adsorbent material is configured to adsorb hydrocarbon gas mixtures, in accordance with one or more embodiments. The steps of method 200 presented below are intended to be illustrative. In some embodiments, method 200 may be accomplished with one or more additional steps not described, and/or without one or more of the steps discussed. Additionally, the order in which the steps of method 200 are shown in FIG. 2 and described below is not intended to be limiting.

At a step 202, a lignocellulose material may be obtained. By way of non-limiting example, the lignocellulose material may include one or more of corncob material, coconut shell material, or other lignocellulose materials.

At a step 204, adsorbent material is produced by performing an activation process on the lignocellulose material such that the lignocellulose material develops a surface area per weight and/or volume suitable for adsorbing hydrocarbon gas mixtures. The activation process may involve use of phosphoric acid, KOH, and/or other compounds. According to some embodiments, the activation process includes quantitatively selecting pore volumes by controlling carbon consumption and intercalation into a carbon lattice of the lignocellulose material.

At a step 206, an activation agent used in the activation process is recycled for use in a later activation process.

FIG. 3 illustrates a method 300 for producing an adsorbent material from a carbon-based nanomaterial, in accordance with one or more embodiments. The adsorbent material is configured to adsorb hydrocarbon gas mixtures. The steps of method 300 presented below are intended to be illustrative. In some embodiments, method 300 may be accomplished with one or more additional steps not described, and/or without one or more of the steps discussed. Additionally, the order in which the steps of method 300 are shown in FIG. 3 and described below is not intended to be limiting.

At a step 302, a carbon-based nanomaterial is obtained. By way of non-limiting example, the carbon-based nanomaterial may include one or more of fullerenes, nanohorns, graphene, or other nanomaterials.

At a step 304, adsorbent material may be produced by performing an activation process on the carbon-based nanomaterial such that the carbon-based nanomaterial develops a surface area per weight and/or volume suitable for adsorbing hydrocarbon gas mixtures. According to some embodiments, the activation process may include one or more of a chemical activation, a physical activation, a controlled oxidation, a carbonization, and/or other steps and/or processes.

FIG. 4 illustrates a method 400 for producing an adsorbent material from a carbonaceous material, in accordance with one or more embodiments. The adsorbent material is configured to adsorb hydrocarbon gas mixtures. The steps of method 400 presented below are intended to be illustrative. In some embodiments, method 400 may be accomplished with one or more additional steps not described, and/or without one or more of the steps discussed. Additionally, the order in which the steps of method 400 are shown in FIG. 4 and described below is not intended to be limiting.

At a step 402, a carbonaceous material is obtained. By way of non-limiting example, the carbonaceous material may include one or more of carbon blacks, surface enhanced flake graphite, nanographite, expandable flake graphite, pitch coke, or other carbonaceous materials.

At a step 404, an adsorbent material is produced by performing an activation process on the carbonaceous, material such that the carbonaceous material develops a surface area per weight and/or volume suitable for adsorbing hydrocarbon gas mixtures. According to some embodiments, the activation process includes one or more of a chemical activation (e.g., using KOH), a physical activation, a controlled oxidation, a carbonization, ultraviolet ozone etching, plasma etching, and/or other steps and/or processes. The activation process may include quantitatively selecting pore volumes by controlling carbon consumption and intercalation into a carbon lattice of the carbonaceous material.

FIG. 5 illustrates a method 500 for producing an adsorbent material from a polymer material, in accordance with one or more embodiments. The adsorbent material is configured to adsorb hydrocarbon gas mixtures. The steps of method 500 presented below are intended to be illustrative. In some embodiments, method 500 may be accomplished with one or more additional steps not described, and/or without one or more of the steps discussed. Additionally, the order in which the steps of method 500 are shown in FIG. 5 and described below is not intended to be limiting.

At a step 502, a polymer material is obtained. By way of non-limiting example, the polymer material may include one or more of polyvinylidene chloride, polyvinyl alcohol, and/or other polymer materials.

At a step 504, an adsorbent material may be produced by performing an activation process on the polymer material such that the polymer material develops a surface area per weight and/or volume suitable for adsorbing hydrocarbon gas mixtures. In some embodiments, the activation process includes one or more of a chemical activation, a physical activation, a controlled oxidation, a carbonization, and/or other steps and/or processes. The activation process may include quantitatively selecting pore volumes by controlling carbon consumption and intercalation into a carbon lattice of the lignocellulose material.

At a step 506, a second stage activation process is performed on the adsorbent material such that the adsorbent material develops an increased surface area per weight and/or volume. The second stage activation process may include one or more steps and/or processes described in connection with step 504.

FIG. 6 illustrates a method 600 for activating carbon-based material using plasma etching or ultraviolet-induced ozone etching to produce an adsorbent material configured to adsorb hydrocarbon gas mixtures, in accordance with one or more implementations. The steps of method 600 presented below are intended to be illustrative. In some embodiments, method 600 may be accomplished with one or more additional steps not described, and/or without one or more of the steps discussed. Additionally, the order in which the steps of method 600 are shown in FIG. 6 and described below is not intended to be limiting.

At a step 602, molecular oxygen is provided proximate to surfaces of the carbon-based material. By way of non-limiting example, the carbon-based material may include one or more of a carbonaceous material, a lignocellulose material, activated carbon material, or other carbon-based material. According to some embodiments, providing the molecular oxygen proximate to the surfaces of the carbon-based material includes irradiating the carbon-based material with ultraviolet light of a second wavelength to effectuate generation of ozone as the molecular oxygen. The second wavelength may be about 185 nanometers. In some embodiments, providing the molecular oxygen proximate to the surfaces of the carbon-based material includes one or both of chemisorbing or physisorbing the molecular oxygen to the surfaces of the carbon-based material. In some embodiments, providing the molecular oxygen proximate to the surfaces of the carbon-based material includes subjecting the carbon-based material to oxygen plasma etching.

At a step 604, the carbon-based material is irradiated with ultraviolet light of a first wavelength to effectuate dissociation of the molecular oxygen to atomic oxygen. The first wavelength may be about 254 nanometers. The atomic oxygen may react with carbon atoms in the carbon-based material. The reaction between the atomic oxygen and the carbon atoms may cause the carbon atoms to be removed from the carbon-based material to create or enhance porosity in the carbon-based material such that the porous carbon-based material is an adsorbent material configured to adsorb hydrocarbon gas mixtures.

In accordance with some embodiments, one or both of surface area per weight and/or volume or pore volume is controlled by (or based on) one or more of irradiation time associated with the ultraviolet light of a first wavelength, irradiation time associated with the ultraviolet light of a second wavelength, oxygen concentration proximate to the carbon-based material, an ambient temperature proximate to the carbon-based material, or other parameters. One or more steps of method 600 may be performed at about room temperature.

FIG. 7 illustrates a method 700 for activating carbon-based material using controlled oxidation to produce an adsorbent material configured to adsorb hydrocarbon gas mixtures, in accordance with one or more embodiments. The steps of method 700 presented below are intended to be illustrative. In some embodiments, method 700 may be accomplished with one or more additional steps not described, and/or without one or more of the steps discussed. Additionally, the order in which the steps of method 700 are shown in FIG. 7 and described below is not intended to be limiting.

Oxygen is not normally used as an activating agent because the carbon-oxygen reaction is highly exothermic and this can make the reaction difficult to control. As a result, molecular oxygen at atmospheric pressure (even air) may simply consume carbon material causing ignition and burning, and sometimes even flames. This occurs from the outside surface and does not penetrate into the interior of the carbon. As a result, no enhancement of porosity may be observed. However, controlled oxidation at low partial pressures and reaction temperatures (e.g., about 600° C.) favor the formation of carbon dioxide and higher controlled reaction temperature (e.g., >900° C.) favor the formation of CO. Carbon atoms have to be available for reaction with an oxygen molecule (not bonded with surface complexes): 2C+O₂=2CO and C+O₂=CO₂.

At a step 702, a carbon-based material is exposed to a sequence of high-temperature loading cycles. The high-temperature loading cycles reach or exceed about 600 degrees Celsius, in some embodiments.

At a step 704, oxygen is degassed during the loading cycles to avoid ignition and burning of the carbon-based material.

FIG. 8 illustrates a method 800 for enhancing surfaces of an adsorbent material configured to adsorb hydrocarbon gas mixtures, in accordance with one or more embodiments. The steps of method 800 presented below are intended to be illustrative. In some embodiments, method 800 may be accomplished with one or more additional steps not described, and/or without one or more of the steps discussed. Additionally, the order in which the steps of method 800 are shown in FIG. 8 and described below is not intended to be limiting.

At a step 802, one or more non-carbon elements may be introduced to surfaces of the adsorbent material to increase a binding energy between methane molecules and the surfaces of the adsorbent material. The increased binding energy may facilitate increased methane uptake. By way of non-limiting example, a given non-carbon element may include iron, lithium, magnesium, chromium, aluminum, sodium, boron, or other non-carbon element.

FIG. 9 illustrates a method 900 for forming hydrates in pores of an adsorbent material configured to adsorb hydrocarbon gas mixtures, in accordance with one or more embodiments. The steps of method 900 presented below are intended to be illustrative. In some embodiments, method 900 may be accomplished with one or more additional steps not described, and/or without one or more of the steps discussed. Additionally, the order in which the steps of method 900 are shown in FIG. 9 and described below is not intended to be limiting.

At a step 902, methane and water is introduced to pores of the adsorbent material to effectuate formation of methane hydrate within the pores. In some embodiments, the water is introduced as water vapor prior to introducing the methane. In some embodiments, the water is introduced as water vapor contemporaneously with the introduction of the methane. In some embodiments, the methane is introduced prior to the water, which is introduced as water vapor.

Sub-nm pores host deep potential wells (i.e., surface sites with high binding energies), which adsorb gas molecules as a high-density fluid. Supra-nm pores host lower binding energies, but offer space for multilayer adsorption. Sub-nm/supra-nm pores give low/high porosity and hence high volumetric/gravimetric energy density.

High performing carbons generally lie on curves defined by high gravimetric excess adsorption (g CH₄/g carbon). Gravimetric excess adsorption may depend on one or more of the surface area of the sorbent, how strongly the surface adsorbs methane (i.e., binding energy of CH₄), and/or whether one or more layers of methane are adsorbed. Higher carbon performance can be obtained by raising one or more of the surface area, binding energy, or number of adsorbed layers. Once a high excess adsorption is reached, the overall volumetric energy density may be tuned by densification.

Methane is a spherical molecule; it is adsorbed by strong van der Waals forces in pores of few molecular diameters as a high-density fluid. FIG. 10 illustrates a simple representation of the effect of pore structure on methane adsorption, in accordance with one or more embodiments. This simple representation is based on methane-carbon interactions in infinite slit shaped micropores by Steele's potential function:

$${φ}_{C \text{-} {CH}_{4}} ( z ) = A \cdot [ \frac{2}{5} {( \frac{{σ}_{C \text{-} {CH}_{4}}}{z } )}^{10} - {( \frac{{σ}_{C \text{-} {CH}_{4}}}{z} )}^{4} ]$$

where A=16.69 kJ/mol (2008 K) and σ_(C—CH_{—}4)=3.61 Å is the zero of the potential and the total potential is the sum of the potentials overlapping from each wall of the slit shaped pore of width H.

Φₜₒₜₐₗ(z)+φ(z)+φ(H−z)

For smaller pores, the potentials from opposite sides of the wall overlap. Consequently, the storage density (g CH4/L carbon) of methane will be higher. However, the mass of the carbon increases and the gravimetric storage capacity (g CH4/Kg carbon) decreases. For larger pores, we have the opposite situation where we have a lower volumetric storage density and a higher gravimetric storage capacity.

Several parameters may to be considered during the optimization process. For example, methane binding energy is higher in sub-nm (1<nm) pores than in supra-nm (1-5 nm) pores because of the overlapping potential. Consequently, the optimal sample may require a large sub-nm (<1 nm) pore volume. As another example, the specific surface area increases the methane excess adsorption according to a relation known as Chahine's rule.

FIG. 10B illustrates a method 1000 for tuning pore volume in a carbon-based adsorbent material, in accordance with one or more embodiments. The steps of method 1000 presented below are intended to be illustrative. In some embodiments, method 1000 may be accomplished with one or more additional steps not described, and/or without one or more of the steps discussed. Additionally, the order in which the steps of method 1000 are shown in FIG. 10B and described below is not intended to be limiting.

At a step 1002, a concentration of an activation agent used to produce or enhance the adsorbent material is adjusted. In some embodiments, the activation agent includes potassium hydroxide.

At a step 1004, an activation temperature is adjusted. According to some embodiments, a volume of supra-nanometer pores in the adsorbent material is proportional to (1) the activation temperature and (2) a weight ratio between the potassium hydroxide and carbon. A supra-nanometer pore has a width of one or more nanometers. In some embodiments, supra-nanometer pores may have width of about one to five nanometers. The size of pores in the adsorbent material may be tailored based on the intended application of the adsorbent material.

According to various embodiments, method 1000 may include adjusting one or more of a pre-activation treatment, an activation method, an activation agent, a mixing procedure, an activation container, homogenization, an activation time, a heating rate, a cooling rate, an activation atmosphere, a gas flow rate, an inlet gas temperature, a washing procedure, or a post-activation treatment.

FIG. 11 illustrates a method 1100 for regenerating an adsorbent material configured to adsorb hydrocarbon gas mixtures, in accordance with one or more embodiments. The steps of method 1100 presented below are intended to be illustrative. In some embodiments, method 1100 may be accomplished with one or more additional steps not described, and/or without one or more of the steps discussed. Additionally, the order in which the steps of method 1100 are shown in FIG. 11 and described below is not intended to be limiting. Depending on the quality of natural gas, an adsorbent material may be contaminated with large hydrocarbons, oil, and/or other contaminants.

At a stem 1102, contaminants are removed from the adsorbent material by performing one or more of: exposing the adsorbent material to a vacuum; exposing the adsorbent material to an elevated temperature; flowing a hot gas through the adsorbent material; or flowing a cold gas through the adsorbent material.

Some adsorbents are manufactured in loose form such as powders, grains, sands, pellets, or other loose forms. The manufacturing of carbon monoliths, for powder-based process, may start with the base powder material to be sintered. Additional binders (and optionally lubricants, dispersants, surfactants, and/or plasticizers) are then mixed into the powder. Once mixed, the mixture is formed into a “green body”. The green body is mechanically strong enough to be handled, but is not yet sintered and is only held together by the strength of the binders. The green body is placed in a furnace where is the temperature profile is controlled and the part is thermally processed into its final form.

Because carbon is such an extremely refractory material, the carbon itself does not sinter. Instead, the binders are pyrolyzed under reducing conditions, wherein the organic components are broken down. Much of the binder leaves the compact as vapor, but a portion of the carbon from the binder remains behind to form bridges between the original carbon grains. The binder formulation is tailored to deliver adequate handling strength while at the same time minimizing the impairment to the function the of activated carbon grains.

A binder formulation and pressing process enables the rapid fabrication of mechanically robust green bodies via uniaxial pressing. The resultant binder formulation will be spray-dried onto the particle, according to some embodiments.

The powder may be pressed to high density in the green state so that the compact can maintain its density throughout subsequent handling and pyrolysis, thereby resulting in a high density and high surface area monolith. Carbon is such a strong material that pressing such powders can be challenging because they tend to “spring back” to low density even after being pressed at very high pressure. Multimodal particle size mixtures can help alleviate this problem.

Once a green body of sufficient density is pressed, it is placed in a furnace for pyrolysis. Furnace capital cost per process volume tends to drop with increasing scale. In some embodiments, large numbers of green bodies will be collected on ceramic trays (known as “boats”) in a batch continuous process a fired together in large furnaces. In very high volumes, continuous belt furnaces may be applied.

FIG. 12 illustrates a method 1200 for producing an adsorbent material monolith configured to adsorb hydrocarbon gas mixtures, in accordance with one or more embodiments. The steps of method 1200 presented below are intended to be illustrative. In some embodiments, method 1200 may be accomplished with one or more additional steps not described, and/or without one or more of the steps discussed. Additionally, the order in which the steps of method 1200 are shown in FIG. 12 and described below is not intended to be limiting.

At a step 1202, an adsorbent material in a loose form may be obtained. By way of non-limiting example, the obtained adsorbent material may comprise one or more of a powder, grains, sands, pellets, or other loose form. According to some embodiments, the loose-form adsorbent material may include differing sizes of one or more of powder, grains, sands, or pellets. The different sizes may be chosen based on their packing properties.

At a step 1204, a loose-form sorbent-binder mixture is obtained by interspersing the loose-form adsorbent material with a binding material in a loose form comprising one or more of a powder, grains, sands, or pellets. FIG. 13A illustrates an exemplary sorbent-binder mixture, in accordance with one or more implementations.

At a step 1206, the loose-form sorbent-binder mixture is compressed to form a green body. FIG. 13B illustrates an exemplary compression of a sorbent-binder mixture, in accordance with one or more embodiments. In some embodiments, the loose-form sorbent-binder mixture is compressed under vacuum. FIG. 14 illustrates a system 1400 configured to compress a loose-form sorbent-binder mixture to form a green body, in accordance with one or more embodiments.

According to some embodiments, apollonian packing may be performed with multiple-particle size distribution by appropriate mixing sequence and vibration (with or without binder and pressure). FIG. 15 illustrates an exemplary result of apollonian packing, in accordance with one or more embodiments.

At a step 1208, pores in the green body are filled with gas or liquid. FIG. 16 illustrates a system 1600 configured to fill pore in a green body with gas or liquid, in accordance with one or more embodiments. By way of non-limiting example, the gas or liquid may include one or more of water vapor, nitrogen, methane, hydrogen, and/or other gas and/or liquid.

At a step 1210, the green body is heated to pyrolyze the binder material to produce the adsorbent material monolith. FIG. 13C illustrates an exemplary result of pyrolysis, in accordance with one or more embodiments. The adsorbent material monolith may be formed in any number of shapes. For example, the adsorbent material monolith is shaped as a briquette, according to some embodiments. As another example, the adsorbent material monolith is shaped so as to have one or more 90 degree edges, in some embodiments. FIG. 17 illustrates exemplary adsorbent material monoliths shaped to facilitate radial filling, in accordance with one or more embodiment.

FIG. 18 illustrates a method 1800 for activating carbon-based material to produce an adsorbent material configured to adsorb hydrocarbon gas mixtures, in accordance with one or more embodiments. The steps of method 1800 presented below are intended to be illustrative. In some embodiments, method 1800 may be accomplished with one or more additional steps not described, and/or without one or more of the steps discussed. For illustrative purposes, FIG. 19 illustrates one or more parameters that may be employed in accordance with execution of the steps of method 1800 as will be brought out in the following descriptions. Additionally, the order in which the steps of method 1800 are shown in FIG. 18 and described below is not intended to be limiting.

At a step 1802, a carbon-based precursor material may be obtained. By way of non-limiting example, the obtained precursor material may comprise one or more of a powder, grains, sands, pellets, or other loose form. The selection of the precursor material suitable for activation may be one or more of the materials outlined in FIG. 20, FIG. 21, FIG. 22, FIG. 23, and FIG. 24. A Norit activated carbon (0460-8) not shown in the figures may be considered. The plot shown in FIG. 25 illustrates the gravimetric excess adsorption achieved for each of the precursor materials. It may be concluded that carbon-based precursors with relatively higher volatile, ash, and oxygen content were best suited for activation.

Returning to FIG. 18, at a step 1804, a mixing procedure may be performed. The mixing procedure may be performed in accordance with a mixing time, temperature, water content, and drying procedure (e.g., based on properties outlined in FIG. 19). FIG. 26, FIG. 27, and FIG. 28 depict the investigated effects of water content, mixing time, and mixing temperature, respectively, on gravimetric excess adsorption.

FIG. 26 plots an effect of water content on gravimetric excess adsorption. In FIG. 26, mixing precursor material AC5 and KOH without water may result in the highest excess adsorption.

FIG. 27 plots the effect of mixing time on gravimetric excess adsorption. It may be concluded that mixing time has a minimal effect on the gravimetric excess adsorption.

FIG. 28 plots the effect of mixing temperature on gravimetric excess adsorption. It may be concluded that the highest gravimetric excess adsorption was achieved for a mixing temperature of 25 C (or about room temperature).

Returning to FIG. 18, at a step 1806, an activation process may be performed. The activation process may be performed in accordance with one or more parameters outlined in FIG. 19. In accordance with one or more embodiments, the effects of nitrogen flow rate during activation were explored. FIG. 29 illustrates standard and direct flow systems used for evaluating the effects of nitrogen flow rates. The plot illustrated in FIG. 30 shows the investigated effects of nitrogen flow rate using the systems illustrated in FIG. 29 on the gravimetric excess adsorption. It may be concluded that nitrogen molecules introduced during activation through direct flow may help metallic potassium get intercalated into the graphitic lattice, and may produce the highest gravimetric excess adsorption.

Returning to FIG. 18, at a step 1808, a post-activation mixing procedure may be performed. The post-activation mixing procedure may be carried out in accordance with one or more parameters outline in FIG. 19.

FIG. 31, FIG. 32, and FIG. 33 illustrate plots of sample measurements for investigating an adsorbent material produced in accordance with one or more embodiments described herein. The sample had a methane isotherm at room temperature from 0 to 35 bar and a data point at 35 bar. Samples were measured gravimetrically and volumetrically, with and without initial vacuum (standard). In reference to FIG. 31, FIG. 32, and FIG. 33, sample MSC-30 had a BET surface area of 3120 m²/g and an apparent density of 0.3 g/cc; sample FAR02 had a BET surface area of 1850 m²/g and an apparent density of 0.31 g/cc; sample MSP-20 had a BET surface area of 2350 m²/g and an apparent density of 0.27 g/cc; and sample A105 is the current highest single-stage activated carbon from coal, in accordance with one or more embodiments described herein.

FIG. 34 illustrates a system 3400 for regenerating an adsorbent material from natural gas contaminants configured to adsorb hydrocarbon gas mixtures. System 3400 provided a setup suitable for investigating the effects of cycling hydrocarbon gas mixtures in and out of storage tanks containing adsorbent material and performing regeneration of the adsorbent material after a number of such cycles. Results from investigation are illustrated in the plots of FIG. 35-FIG. 42 which measured gravimetric excess adsorption, gravimetric storage capacity, and volumetric storage capacity of the adsorbent material after cycle numbers 5, 10, 20, 40, 60, 80, 100, 150, 200, 300, 400, and 500. The natural gas composition was measured initially (FIG. 36) and at cycles 100 (FIG. 40) and 500 (FIG. 41).

FIG. 43 and FIG. 44 depict tables of investigational results of various regeneration techniques (for example, using system 3400 in FIG. 34) used to at least partially restore adsorption capabilities of adsorbent material used in the storage and/or transport of hydrocarbon gas mixtures (e.g., performed after repeating filling and emptying cycles). Repeated filling and emptying of a tank containing adsorbent material with a hydrocarbon gas mixture may lead to degradation of the adsorption capabilities of the adsorption material. Various regeneration techniques have been evaluated, in accordance with one or more embodiments described herein. Through the addition of adsorbent material regeneration after a number of the cycles of filling and emptying a tank associated with storing and/or transporting hydrocarbon gas mixtures, the adsorption capabilities of the adsorbent material may be at least partially restored and the longevity and cost effectiveness of storing and/or transporting such gasses may be optimized.

FIG. 60 illustrates a method 6000 for storing hydrocarbon gas mixtures including one or more regeneration techniques to at least partially restore adsorption capabilities of an adsorbent material used in the storage of the gas mixture, in accordance with one or more embodiments. The steps of method 6000 presented below are intended to be illustrative. In some embodiments, method 6000 may be accomplished with one or more additional steps not described, and/or without one or more of the steps discussed. Additionally, the order in which the steps of method 6000 are shown in FIG. 60 and described below is not intended to be limiting.

At a step 6002, a tank may be filled with a hydrocarbon gas mixture. The tank may contain an adsorbent material configured to receive the hydrocarbon gas mixture by adsorption. The adsorbent material may be an adsorbent material in accordance with one or more embodiments described herein. The filling process may completely or partially fill the tank.

At a step 6004, the hydrocarbon gas mixture may be emptied from the tank by desorbing the hydrocarbon gas mixture from the adsorbent material. As used herein, the emptying process may be complete or partial, and may occur in stages (e.g., partial emptying followed by a pause and then additional emptying).

At a step 6006, the filling and emptying of the tank may be repeated for a number of cycles. According to various embodiments, each fill/empty cycle comprises at least partial filling, followed by at least partial emptying. Consequently, a fill/empty cycle may comprise filling a tank from 70% full to 80% full, followed by emptying the tank from 80% full to 65% full. Subsequent fill/empty cycles may comprise different degrees of filling and emptying.

At a step 6008, the adsorbent material may be regenerated after a number of cycles of filling and emptying in order to at least partially restore adsorption capabilities of the adsorbent material. In some embodiments, regeneration may be performed after at least one cycle. In some embodiments, regeneration may be performed after at least two cycles. In some embodiments, regeneration may be performed after up to 500 cycles (or more). For example FIG. 43 and FIG. 44 illustrate investigative results for preforming regeneration after the 100^{th} cycle of filling and emptying. In some embodiments, regeneration is cyclically performed at least as often as once every 1, 2, 3, 4, 5, 6, 7, 8, 9, 10, 15, 20, 25, 30, 40, 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, 600, 700, 800, 900, 1000, 2000, 3000, 4000, and/or 5000 fill/empty cycles.

According to various embodiments, the cyclic regeneration can occur at different frequencies. For example, the fill/empty cycle period between each regeneration may get progressively shorter as the tank ages and/or the total number of fill/empty cycles increases.

According to various embodiments, the regeneration frequency may additionally and/or alternatively be based on a variety or other criteria. For example, in one or more embodiments, the period between each regeneration cycle is based on the mass of gas that has flowed through the tank. For example, for a tank that has a certain gas (e.g. natural gas, methane, etc.) mass capacity at a given pressure (e.g., 500 psig, 1000 psig, 2000 psig, 2500 psig, 3000 psig, and/or 2600 psig) and temperature (e.g., room temperature, 25° C.), the tank may undergo a regeneration cycle after a predetermined multiple of that capacity has flowed through the tank. According to various embodiments, the gas mass capacity may be based on the tank's capacity when the adsorbent material is fresh (before initial use), or immediately after a regeneration cycle. Alternatively, the gas mass capacity of the tank may be defined as the tank's gas mass capacity at such a pressure and temperature if the tank did not contain adsorbent material. Such gas flow may be measured as the mass of gas flowing into the tank or the mass of gas flowing out of the tank. The gas flow may be measured by a mass gas flow meter, and/or calculated using another type of flow meter (e.g., a volumetric flow meter, a flow rate meter, etc.). According to various embodiments, regeneration is cyclically performed at least as often as once each time that that 5000, 4000, 3000, 2000, 1000, 900, 800, 700, 600, 500, 400, 300, 200, 100, 90, 80, 70, 60, 50, 40, 30, 25, 20, 15, 10, 9, 8, 7, 6, 5, 4, 3, 2, and/or 1 times the certain gas mass capacity of the tank has flowed into or out of the tank.

The frequency of regeneration cycles may alternatively be determined based on an algorithm that accounts for both the number of fill/empty cycles and the mass of gas that flows into or out of the tank. For example, the period between regeneration cycles may be set to a mass flow through the tank of X times the gas mass capacity multiplied by (Y−Z)/Y, where Y is a predetermined number of fill/empty cycles, and Z is the number of fill/empty cycles since the last regeneration. According to various embodiments, X may be any of the above-discussed multiples of the gas mass capacity, and Y may be any of the above-discussed numbers of fill/empty cycles to be used between regenerations according to the above-discussed embodiments.

According to various embodiments, different regeneration cycles may vary. For example, a partial regeneration cycle (e.g., limited time, vacuum, and/or temperature) may occur more frequently (e.g., 4 out of 5 regeneration cycles) than a more thorough regeneration cycle (e.g., a regeneration cycle having a longer duration, larger vacuum, and or higher temperature every fifth regeneration cycle)

The regeneration of the adsorption material may be performed in accordance with one or more of the techniques outlined in FIG. 43 and FIG. 44. Generally, the regeneration of the adsorbent material at step 6008 may comprise one or both of exposing the adsorbent material to a vacuum; or exposing the adsorbent material to an elevated temperature, described in more detail herein.

In some embodiments, the vacuum may have a pressure between 10⁻¹ torr and 10⁻⁵ torr. For example FIG. 43 and FIG. 44 illustrate investigative results for preforming regeneration by exposing the adsorbent material to a vacuum pressure up to 10⁻⁴ torr. In some embodiments, exposing the adsorbent material to a vacuum may comprise exposing the adsorbent material to a vacuum having a pressure of (a) less than 10⁻¹ torr, 5.5×10⁻² torr, 10⁻² torr, 5.5×10⁻³ torr, 10⁻³ torr, 5.5×10⁻⁴ torr, 10⁻⁴ torr, 5.5×10⁻⁵ torr, and/or 10⁻⁵ torr, (b) greater than 10⁻¹ torr, 5.5×10⁻² torr, 10⁻² torr, 5.5×10⁻³ torr, 10⁻³ torr, 5.5×10⁻⁴ torr, 10⁻⁴ torr, 5.5×10⁻⁵ torr, and/or 10⁻⁵ torr, and/or (c) between any two of these upper and lower boundaries.

In some embodiments, exposing the adsorbent material to the vacuum during regeneration may be performed for a duration between 0.5 hour and 120 hours. For example FIG. 43 and FIG. 44 illustrate investigative results for preforming regeneration by exposing the adsorbent material to a vacuum for 2 hours. In some embodiments, exposing the adsorbent material to the vacuum during regeneration may be performed for a duration of between 0.25 and 120 hours, between 0.5 hours and 12 hours, between 0.5 and 6 hours, and/or between 0.5 and 4 hours. According to various embodiment, the duration is at least 0.1, 0.25, 0.5, 1, 1.25, 1.5, 1.75, 2, 3, 4, 5, 6, 7, 8, 9, 10, 12, 14, 16, 18, 20, 24, 36, 48, 72, 96 and/or 120 hours. According to various embodiments, the duration is less than 144, 120, 96, 72, 48, 36, 24, 22, 20, 18, 16, 14, 12, 10, 9, 8, 7, 6, 5, 4, 3, 2, 1.75, 1.5, 1.25, 1.0, 0.75, and/or 0.5 hours. According to various embodiments, the duration may be between any combination of these upper and lower boundaries.

In some embodiments, the temperature at which the adsorbent material is exposed may be between 50° C. and 400° C. For example FIG. 43 and FIG. 44 illustrate investigative results for preforming regeneration by exposing the adsorbent material to temperatures of 50° C., 100° C., 200° C., and 400° C. In some embodiments, the temperature may be at least 50° C., 75° C., 100° C., 125° C., 150° C., 175° C., 200° C., 225° C., 250° C., 275° C., 300° C., 325°, 350° C., 375° C., 400° C., 500° C., and/or 600° C. In some embodiments, the temperature may be less than 75° C., 100° C., 125° C., 150° C., 175° C., 200° C., 225° C., 250° C., 275° C., 300° C., 325° C., 350° C., 375° C., 400° C., 500° C., and/or 600° C. According to various embodiments, the temperature may be between any combination of these upper and lower boundaries.

In some embodiments, the adsorbent material may be exposed to the elevated temperature during regeneration for a duration between 0.5 hour and 4 hours. In some embodiments, the adsorbent material may be exposed to the elevated temperature during regeneration for a duration selected from the group consisting of 0.5 hour, 0.75 hour, 1.0 hour, 1.25 hours, 1.5 hours, 1.75 hours, 2.0 hours, 2.25 hours, 2.5 hours, 2.75 hours, 3.0 hours, 3.25 hours, 3.5 hours, 3.75 hours, and 4.0 hours.

In some embodiments, regeneration of adsorbent material at step 6008 may comprise flowing a gas through the adsorbent material to purge adsorbed material. The gas may be nitrogen gas. For example, FIG. 43 illustrates investigational results for regenerating adsorbent material via 0.5 hour of nitrogen gas flow, 1 hour of nitrogen gas flow, and 2 hours of nitrogen gas flow. In some embodiments, the adsorbent material may be exposed to a flow of gas during regeneration for a duration selected from the group consisting of 0.5 hour, 0.75 hour, 1.0 hour, 1.25 hours, 1.5 hours, 1.75 hours, 2.0 hours, 2.25 hours, 2.5 hours, 2.75 hours, 3.0 hours, 3.25 hours, 3.5 hours, 3.75 hours, and 4.0 hours.

FIG. 63 illustrates a single tank system 6300 for storing hydrocarbon gas mixtures that is configured to regenerate adsorbent material to at least partially restore adsorption capabilities of an adsorbent material used in the storage of the gas mixtures, in accordance with one or more embodiments. The description of system 6300 presented below are intended to be illustrative. In some embodiments, system 6300 may include one or more additional components not described, and/or may be configured without one or more of the components discussed. Additionally, the placement and/or configuration of the various components of system 6300 shown in FIG. 63 and described below is not intended to be limiting.

In some embodiments, system 6300 comprises tank 6302 configured to store a hydrocarbon gas mixture. Tank 6302 may be configured to receive a flow of hydrocarbon gas mixture. A hydrocarbon gas mixture may be communicated into an interior volume of tank 6302 from a hydrocarbon gas mixture source 6304. In some embodiments, hydrocarbon gas mixture source 6304 may be configured to regulate the flow of gas into tank 6302. In some embodiments, tank 6302 may include one or more components to regulate the flow of gas into tank 6302 communicated from hydrocarbon bas mixture source 6304.

In some embodiments, the filling process may completely or partially fill tank 6302. Tank 6302 may contain an adsorbent material configured to receive the hydrocarbon gas mixture by adsorption. The adsorbent material may be an adsorbent material in accordance with any one or more embodiments described herein.

Tank 6302 may be configured to empty the hydrocarbon gas mixture through valved gas outlet 6314 of tank 6302 by desorbing the hydrocarbon gas mixture from the adsorbent material. The emptying process may be complete or partial, and may occur in stages (e.g., partial emptying followed by a pause and then additional emptying).

According to various alternative embodiments, any two or more of the inlet and/or outlet ports in the tank 6302 may be merged and then branched out. For example, according to various alternative embodiments, the gas outlet 6314 and gas inlet from the gas source 6304 into the tank 6302 may be combined such that gas is filled into the tank 6302 and emptied out of the tank 6302 through a common port that branches out to the source 6304 and valve for the gas outlet.

The tank 6302 may be cyclically filled and emptied with gas as described in connection with any of the above-discussed embodiments.

In some embodiments, system 6300 may facilitate or automatically carry out the regeneration of adsorbent material contained within the interior volume of the tank 6302. For example, as explained above, the system 6300 may regenerate the adsorbent material at a frequency based on the number of fill/empty cycles and/or a mass of gas that flows through the tank 6302. Alternatively, the system 6300 may use any other regeneration scheme without deviating from the scope of the present invention.

The regeneration of the adsorption material may be performed in accordance with one or more of the techniques described herein, for example in accordance with one or more steps outlined in method 6000. Generally, the regeneration of the adsorbent material may comprise exposing the adsorbent material to a vacuum facilitated by a vacuum source, such as vacuum pump 6308, in communication with the interior volume of tank 6302; and/or exposing the adsorbent material to an elevated temperature facilitated by a heat source, such as heater 6310, in communication with the interior volume of tank 6302. In some embodiments regeneration of adsorbent material may be facilitated through the introduction of a purge gas communicated into the interior volume of tank 6302 from purge gas source 6308 to purge the adsorbed material. In some embodiments, the purge gas may comprise nitrogen gas, argon gas, and/or another inert gas. According to various embodiments, the purge gas comprises at least 50, 60, 70, 80, and/or 90 weight or volume percent nitrogen, argon, and/or another inert gas.

In some embodiments, gas that has desorbed from the adsorbent material responsive to the vacuum and elevated temperature may be vented from tank 6302 through valved vent gas outlet 6312.

According to alternative embodiments, the purge gas may be supplied to the tank 6302 and/or vented from the tank 6302 through any other port in the tank 6302. For example, according to one or more alternative counterflow embodiments, the purge gas supply 6306 is connected to the gas outlet 6314 so that the purge gas is injected into the tank 6302 through the outlet 6314. In such embodiments, the purge gas may exit the tank 6302 out of the inlet through which the hydrocarbon gas mixture source 6304 supplies hydrocarbon gas to the tank 6302. In such an embodiment, the purge gas flows in a counterflow direction relative to a directing that hydrocarbon gas (e.g., natural gas) flows through the tank 6302. Such counterflow of purge gas may aid in the regeneration of the adsorbent material in the tank 6302 by flushing larger hydrocarbon molecules and/or other molecules and contaminants out of the tank 6302 in a back-flushing manner.

In some embodiments, one or more of the procedures of filling, emptying, and/or regenerating adsorbent material may be carried out and controlled by controller 6316 communicating with one or more of hydrocarbon gas mixture source 6302, purge gas source 6306, vacuum pump 6308, heater 6310, and valved outlets 6312, 6314 (as well as any other controllable component of the system 6300). The controller 6316 may include one or more physical processes configured by computer-readable instructions to preform one or more operations as described herein. For example, controller 6316 may be configured by computer-readable instructions to perform operations for filling, emptying, and/or regenerating adsorbent material in accordance with one or more of the steps of method 6000 described herein.

FIG. 61 illustrates a method 6100 for regenerating an adsorbent material configured to adsorb hydrocarbon gas mixtures in order to at least partially restore adsorption capabilities of the adsorbent material. The adsorbent material may be contained by an interior volume of a tank. The steps of method 6100 presented below are intended to be illustrative. In some embodiments, method 6100 may be accomplished with one or more additional steps not described, and/or without one or more of the steps discussed. Additionally, the order in which the steps of method 6100 are shown in FIG. 61 and described below is not intended to be limiting.

At a step 6102, the adsorbent material may be exposed to a vacuum and an elevated temperature after a number of cycles that include at least partially filling the tank once with a hydrocarbon gas mixture and at least partially emptying the tank of the hydrocarbon gas mixture once.

In some embodiments, the vacuum may have a pressure between 10⁻¹ torr and 10⁻⁵ torr. In some embodiments, exposing the adsorbent material to a vacuum may comprise exposing the adsorbent material to a vacuum having a pressure selected from a group consisting of 10⁻¹ torr, 5.5×10⁻² torr, 10⁻² torr, 5.5×10⁻³ torr, 10⁻³ torr, 5.5×10⁻⁴ torr, 10⁻⁴ torr, 5.5×10⁻⁵ torr, and 10⁻⁵ torr.

In some embodiments, exposing the adsorbent material to the vacuum during regeneration may be performed for a duration of between 0.25 and 120 hours, between 0.5 hours and 12 hours, between 0.5 and 6 hours, and/or between 0.5 and 4 hours. According to various embodiment, the duration is at least 0.1, 0.25, 0.5, 1, 1.25, 1.5, 1.75, 2, 3, 4, 5, 6, 7, 8, 9, 10, 12, 14, 16, 18, 20, 24, 36, 48, 72, 96 and/or 120 hours. According to various embodiments, the duration is less than 144, 120, 96, 72, 48, 36, 24, 22, 20, 18, 16, 14, 12, 10, 9, 8, 7, 6, 5, 4, 3, 2, 1.75, 1.5, 1.25, 1.0, 0.75, and/or 0.5 hours. According to various embodiments, the duration may be between any combination of these upper and lower boundaries.

In some embodiments, the temperature at which the adsorbent material is exposed may be between 50° C. and 600° C. and/or between 50° C. and 400° C. In some embodiments, the temperature may be at least 50° C., 75° C., 100° C., 125° C., 150° C., 175° C., 200° C., 225° C., 250° C., 275° C., 300° C., 325° C., 350° C., 375° C., 400° C., 500° C., and/or 600° C. In some embodiments, the temperature may be less than 75° C., 100° C., 125° C., 150° C., 175° C., 200° C., 225° C., 250° C., 275° C., 300° C., 325° C., 350° C., 375° C., 400° C., 500° C., and/or 600° C. According to various embodiments, the temperature may be between any combination of these upper and lower boundaries.

(279). In some embodiments, the adsorbent material may be exposed to the elevated temperature during regeneration for a duration between 0.25 and 120 hours, between 0.5 hours and 12 hours, between 0.5 and 6 hours, and/or between 0.5 and 4 hours. According to various embodiment, the duration is at least 0.1, 0.25, 0.5, 1, 1.25, 1.5, 1.75, 2, 3, 4, 5, 6, 7, 8, 9, 10, 12, 14, 16, 18, 20, 24, 36, 48, 72, 96 and/or 120 hours. According to various embodiments, the duration is less than 144, 120, 96, 72, 48, 36, 24, 22, 20, 18, 16, 14, 12, 10, 9, 8, 7, 6, 5, 4, 3, 2, 1.75, 1.5, 1.25, 1.0, 0.75, and/or 0.5 hours. According to various embodiments, the duration may be between any combination of these upper and lower boundaries.

At a step 6104, gas that has desorbed from the adsorbent material responsive to the vacuum and elevated temperature may be vented from the tank.

FIG. 62 illustrates a method 6200 for regenerating an adsorbent material configured to adsorb hydrocarbon gas mixtures in order to at least partially restore adsorption capabilities of the adsorbent material. The steps of method 6200 presented below are intended to be illustrative. In some embodiments, method 6200 may be accomplished with one or more additional steps not described, and/or without one or more of the steps discussed. Additionally, the order in which the steps of method 6200 are shown in FIG. 62 and described below is not intended to be limiting. In some embodiments, the steps of method 6200 may be performed with adsorbent material contained within the interior volumes of two tanks.

At a step 6202, a hydrocarbon gas mixture may be stored in one of the two tanks while adsorbent material contained within the other tank may be regenerated. The other tank may be substantially empty of hydrocarbon gas mixture during regeneration. For example; the tanks may include a first tank and a second tank, both having interior volumes containing adsorbent material. The first tank may store a hydrocarbon gas mixture. The second tank may regenerate adsorbent material contained within the second tank. During regeneration, the second tank may be substantially empty of the hydrocarbon gas mixture. At a step 6204, the storage of the hydrocarbon gas mixture and regeneration of adsorbent material between the two tanks may be alternated. At any given time at least one tank may be storing a hydrocarbon gas mixture while the other tank is regenerating adsorbent material. For example; the storage of a hydrocarbon gas mixture and regeneration of adsorbent material with the first tank and the second tank may be alternated. At a subsequent moment in time, the first tank may be substantially emptied of the hydrocarbon gas mixture and the adsorbent material contained within the first tank may be regenerated. The second tank may be filled (e.g., to store) a hydrocarbon gas mixture. (202) FIG. 64 illustrates a system 6400 for regenerating an adsorbent material configured to adsorb hydrocarbon gas mixtures in order to at least partially restore adsorption capabilities of the adsorbent material. The description of system 6400 presented below is intended to be illustrative. In some embodiments, system 6400 may include one or more additional components not described, and/or may be configured without one or more of the components discussed. Additionally, the placement and/or configuration of the various components of system 6400 shown in FIG. 64 and described below is not intended to be limiting. In some embodiments system 6400 comprises a first tank 6402 having an interior volume containing adsorbent material configured to receive a hydrocarbon gas mixture by adsorption, and a second tank 6404 having an interior volume containing adsorbent material configured to receive a hydrocarbon gas mixture by adsorption. In some embodiments, a hydrocarbon gas mixture may be stored in first tank 6402 while adsorbent material contained within second tank 6404 may be regenerated. Second tank 6404 may be substantially empty of hydrocarbon gas mixture during regeneration. The storage of a hydrocarbon gas mixture and regeneration of adsorbent material with the first tank 6402 and the second tank 6404 may be alternated through operations the same or similar as the steps of method 6200 presented above.

In some embodiments, filling the first tank 6402 and/or second tank 6404 with a hydrocarbon gas mixture may be facilitated by a hydrocarbon gas mixture source 6406 in fluid communication with the respective interior volumes. In some embodiments, hydrocarbon gas mixture source 6406 may be configured to regulate the flow of gas into first tank 6402 and/or second tank 6404. In some embodiments, first tank 6402 and/or second tank 6404 may include one or more components to regulate the flow of gas communicated from hydrocarbon gas mixture source 6404.

Emptying first tank 6402 and/or second tank 6404 of the hydrocarbon gas mixture may be facilitated by valved gas outlets 6418, 6420 respectively, by desorbing the hydrocarbon gas mixture from the adsorbent material. In some embodiments valved gas outlets 6418, 6420 may be joined at a common outlet port for emptying hydrocarbon gas mixtures as shown in FIG. 64, however in other embodiments it is envisioned that valved gas outlets 6418, 6420 may empty gas through separate and distinct outlet ports.

In some embodiments, regenerating the adsorbent material in first tank 6402 and/or second tank 6404 may comprise exposing the adsorbent material to a vacuum facilitated by a vacuum source such as vacuum pump 6410 in communication with the interior volumes of first tank 6402 and/or second tank 6404; and/or exposing the adsorbent material to an elevated temperature. In some embodiments, exposing the adsorbent material to an elevated temperature may be facilitated by heat transfer component 6412 (e.g., an active or passive heat pump) communicating between first tank 6402 and second tank 6404 configured to capture and transfer heat generated during the filling of one of the tanks 6402, 6404 (e.g., resulting from compression and adsorption of the hydrocarbon gas mixture) and exposing the heat to the adsorbent material contained in the other tank 6402, 6404.

In some embodiments regeneration of adsorbent material may be facilitated through the introduction of a purge gas communicated into the respective interior volumes of first tank 6402 and/or second tank 6404 from purge gas source 6408 to purge the adsorbed material. The purge gas may comprise any of the above-discussed purge gases (e.g., as described with respect to the system 6300) and/or other purge gas(es). According to various alternative embodiments, the purge gas is fed through the tank 6402, 6404 in a counterflow direction, in the same or similar manner as described above with respect to an alternative embodiment of the system 6300.

In some embodiments, gas that has desorbed from the adsorbent material responsive to the vacuum and elevated temperature may be vented from the first tank 6402 and/or second tank 6404 through respective valved vent gas outlets 6414, 6416.

In some embodiments, one or more of the procedures of filling, emptying, and/or regenerating adsorbent material may be facilitated by controller 6422 communicating with one or more of hydrocarbon gas mixture source 6406, purge gas source 6408, vacuum pump 6410, heat transfer 6412, valved outlets 6414, 6416, 6418, 6420, and/or any other controllable component of the system 6400 (e.g., other valves to facilitate desired flows). For example controller 6422 may control the cycles of opening and closing valved outlets 6414, 6416, 6418, 6420 as described herein for filling, emptying, and regeneration. The controller 6422 may include one or more physical processes configured by computer-readable instructions to preform one or more operations as described herein. For example, controller 6422 may be configured by computer-readable instructions to perform operations for filling, emptying, and/or regenerating adsorbent material in accordance with one or more of the steps of method 6200 presented above, and/or switching between such procedures. According to various embodiments, the controller 6422 may automatically switch between different modes (e.g., into and out of a regeneration cycle) automatically or in response to a user-input.

According to various alternative embodiments, any two or more of the inlet and/or outlet ports in the tank 6402 or the tank 6404 may be merged and then branched out, in the same or similar manner as described above with respect to the system 6300.

One or more of the techniques for storing a hydrocarbon gas mixture in a storage tank including an adsorbent material configured to adsorb the hydrocarbon gas mixture (e.g., natural gas) (with or without regenerating the adsorbent material) as described herein may be suitable for various applications of hydrocarbon gas mixture storage and/or transportation. In some embodiments, tanks used for storage and/or transportation of a hydrocarbon gas mixture may be implemented as stationary storage tanks, for example, any one or more of the stationary storage tanks (e.g., vessels 141, 143, 241, 441i, 442i, 643, the distribution centers 1910, mother or daughter stations) described in PCT Publication No. WO2014/031999. Various embodiments are particularly well suited for stationary gas storage in view of the weight of adsorbent-filled tanks according to some embodiments. In some embodiments, tanks used for storage and/or transportation of a hydrocarbon gas mixture may be implemented as mobile storage tanks, for example:
(a) storage tanks mounted on or incorporated into rail cars for transporting gas such as natural gas by rail;
(b) storage tanks mounted on or incorporated into ships or barges for transporting gas such as natural gas over water (e.g., over lakes, rivers, gulfs, seas, oceans); and
(c) terrestrial transportation such as storage tanks mounted on wheeled frames (e.g., trailers, trucks, etc.) for transporting gas such as natural gas over roads (e.g., the mobile storage vessels 122, 142, 622 described in PCT Publication No. WO2014/031999).
   According to various embodiments, such mobile storage tanks and methods are suitable for transportation distances over which natural gas liquefaction is not justified.
   In some embodiments, tanks and methods may comprise fuel tanks for gas powered vehicles (e.g., vehicles such as personal, commercial, industrial, construction, and/or fleet cars, trucks, and/or other vehicles and automobiles). Use of these embodiments as fuel tanks may advantageously facilitate fuel tanks that contain more fuel, are physically smaller, and/or operate at lower pressures than some conventional fuel tanks. These stationary and/or mobile storage vessels may incorporate any of the features of any of the embodiments disclosed herein (e.g., adsorbents, regeneration, repetitive regeneration, etc.).

FIG. 45 illustrates a method 4500 for producing an adsorbent material monolith configured to adsorb hydrocarbon gas mixtures, in accordance with one or more embodiments. The steps of method 4500 presented below are intended to be illustrative. In some embodiments, method 4500 may be accomplished with one or more additional steps not described, and/or without one or more of the steps discussed. For illustrative purposes, FIG. 46 illustrates one or more parameters employed in accordance with execution of the steps of method 4500 as will be brought out in the following descriptions. Additionally, the order in which the steps of method 4500 are shown in FIG. 45 and described below is not intended to be limiting.

At a step 4502, a powder precursor material may be obtained. The material may be in accordance with one or more of the materials listed in FIG. 46. FIG. 48 shows the effect of three different precursors with PVA binder on volumetric storage capacity. The results indicated that the precursor selection may have minimal effect on the volumetric storage capacity. However, the density and the gravimetric storage capacity may be highly dependent on the precursor.

At a step 4504, a binder mixture may be obtained. FIG. 47 illustrates the effect the binder had on volumetric storage capacity. Evaluation was performed with PVA, methyl cellulose, humic acid 82, and expandable natural graphite (ENG). PVA binder may have generated the highest volumetric storage; however, the synthesis procedure may have been complicated. Methylcellulose may have not required heat during compaction. Expandable natural graphite binder may have increased the thermal conductivity.

FIG. 49 and FIG. 50 depict plots illustrating the investigated effect of binder concentration on volumetric storage capacity for PVA (FIG. 49) and ENG (FIG. 50). For ENG, a binder to carbon ratio of 55:45 may produce the highest volumetric storage capacity. However, for PVA, the binder concentration may have had minimal effect on the volumetric storage capacity. This may have been explained by the fact that volumetric storage capacity may be dependent both, on the density and the gravimetric excess adsorption.

FIG. 51 depicts a plot illustrating the investigated effect of compaction pressure on volumetric storage capacity. The plot may have indicated that the compaction pressure may have minimal effect on the volumetric storage capacity. For instance, increasing the compaction pressure may increase the pellet density; however it may decrease the excess adsorption.

Many other parameters were investigated separately for every pellet (e.g., pressure and temperature rate, cooling procedure, and pyrolysis condition . . . ). Every pellet measured may have a methane isotherm at room temperature from 0 to 35 bar (measured using a volumetric setup) and a data point at 35 bar (measured using a gravimetric setup). The findings are summarized in FIG. 52. The solid data points represent pellets produced through one or more of the methods described herein.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A method for producing an adsorbent material configured to adsorb hydrocarbon gas mixtures, the method comprising:
obtaining an activated carbon material having a first surface area per weight and/or volume; and
performing a second stage activation process on the activated carbon material such that the activated carbon develops a second surface area per weight and/or volume, the second surface area per weight and/or volume being greater than the first surface area per weight and/or volume.

2. The method of claim 1, wherein the first surface area per weight and/or volume is less than about 1200 square meters per gram.

3. The method of claim 1, wherein the second surface area per weight and/or volume is greater than about 3000 square meters per gram.

4. The method of claim 1, wherein the second stage activation process includes a combination of two or more of a chemical activation, a physical activation, a controlled oxidation, ultraviolet-ozone etching, plasma etching, or a carbonization.

5. The method of claim 1, further comprising performing a third stage activation process on the activated carbon material such that the activated carbon develops a third surface area per weight and/or volume, the third surface area per weight and/or volume being greater than the second surface area per weight and/or volume.

6. The method of claim 1, further comprising recycling an activation agent used in the second state activation process for use in a later activation process.

7. An adsorbent material configured to adsorb hydrocarbon gas mixtures, the adsorbent material being prepared by a process comprising the steps of claim 1.

8. A method for producing an adsorbent material from a lignocellulose material, the adsorbent material being configured to adsorb hydrocarbon gas mixtures, the method comprising:
obtaining the lignocellulose material; and
producing the adsorbent material by performing an activation process on the lignocellulose material such that the lignocellulose material develops a surface area per weight and/or volume suitable for adsorbing hydrocarbon gas mixtures, the activation process including quantitatively selecting pore volumes by controlling carbon consumption and intercalation into a carbon lattice of the lignocellulose material.

9. The method of claim 8, wherein the lignocellulose material includes one or more of corncob material or coconut shell material.

10. The method of claim 8, further comprising recycling an activation agent used in the activation process for use in a later activation process.

11. An adsorbent material configured to adsorb hydrocarbon gas mixtures, the adsorbent material being prepared by a process comprising the steps of claim 8.

12. A method for producing an adsorbent material from a carbonaceous material, the adsorbent material being configured to adsorb hydrocarbon gas mixtures, the method comprising:
obtaining a carbonaceous material; and
producing the adsorbent material by performing an activation process on the carbonaceous material such that the carbonaceous material develops a surface area per weight and/or volume suitable for adsorbing hydrocarbon gas mixtures.

13. The method of claim 12, wherein the carbonaceous material includes one or more of carbon blacks, surface enhanced flake graphite, nanographite, expandable flake graphite, or pitch coke.

14. The method of claim 12, wherein the activation process includes one or more of a chemical activation, a physical activation, a controlled oxidation, or a carbonization.

15. The method of claim 12, wherein the activation process includes quantitatively selecting pore volumes by controlling carbon consumption and intercalation into a carbon lattice of the carbonaceous material.

16. An adsorbent material configured to adsorb hydrocarbon gas mixtures, the adsorbent material being prepared by a process comprising the steps of claim 12.

17. A method for activating carbon-based material using controlled oxidation to produce an adsorbent material configured to adsorb hydrocarbon gas mixtures, the method comprising:
exposing the carbon-based material to a sequence of high-temperature loading cycles; and
degassing oxygen during the loading cycles to avoid ignition and burning of the carbon-based material.

18. The method of claim 17, wherein the high-temperature loading cycles reach or exceed about 600 degrees Celsius.

19. An adsorbent material configured to adsorb hydrocarbon gas mixtures, the adsorbent material being prepared by a process comprising the steps of claim 17.

20. A method for enhancing surfaces of an adsorbent material configured to adsorb hydrocarbon gas mixtures, the method comprising:
introducing one or more non-carbon elements to surfaces of the adsorbent material to increase a binding energy between methane molecules and the surfaces of the adsorbent material.

21. The method of claim 20, wherein the one or more non-carbon elements include one or more of iron, lithium, magnesium, chromium, aluminum, sodium, or boron.

22. An adsorbent material having enhanced surfaces and configured to adsorb hydrocarbon gas mixtures, the adsorbent material being prepared by a process comprising the step of claim 20.

23. A method for forming hydrates in pores of an adsorbent material configured to adsorb hydrocarbon gas mixtures, the method comprising:
introducing methane and water to pores of the adsorbent material to effectuate formation of methane hydrate within the pores.

24. The method of claim 23, wherein the water is introduced as water vapor prior to introducing the methane.

25. The method of claim 23, wherein the water is introduced as water vapor contemporaneously with the introduction of the methane.

26. The method of claim 23, wherein the methane is introduced prior to the water, the water being introduced as water vapor.

27. An adsorbent material configured to adsorb hydrocarbon gas mixtures, the adsorbent material being prepared by a process comprising the step of claim 23.

28. A method for tuning pore volume in a carbon-based adsorbent material, the method comprising:
adjusting a concentration of an activation agent used to produce or enhance the adsorbent material, the activation agent including potassium hydroxide; and
adjusting an activation temperature;
wherein a volume of supra-nanometer pores in the adsorbent material is proportional to (1) the activation temperature and (2) a weight ratio between the potassium hydroxide and carbon.

29. The method of claim 28, further comprising adjusting one or more of a pre-activation treatment, an activation method, an activation agent, a mixing procedure, an activation container, homogenization, an activation time, a heating rate, a cooling rate, an activation atmosphere, a gas flow rate, an inlet gas temperature, a washing procedure, or a post-activation treatment.

30. A method for regenerating an adsorbent material configured to adsorb hydrocarbon gas mixtures, the method comprising:
removing contaminants from the adsorbent material by performing one or more of:
exposing the adsorbent material to a vacuum;
exposing the adsorbent material to an elevated temperature;
flowing a hot gas through the adsorbent material; or
flowing a cold gas through the adsorbent material.

31. A method for producing an adsorbent material monolith configured to adsorb hydrocarbon gas mixtures, the method comprising:
obtaining an adsorbent material in a loose form comprising one or more of a powder, grains, sands, or pellets;
obtaining a loose-form sorbent-binder mixture by interspersing the loose-form adsorbent material with a binding material in a loose form comprising one or more of a powder, grains, sands, or pellets;
compressing the loose-form sorbent-binder mixture to form a green body; and
heating the green body to pyrolyze the binder material to produce the adsorbent material monolith.

32. The method of claim 31, wherein the loose-form sorbent-binder mixture is compressed under vacuum.

33. The method of claim 31, further comprising filling pores in the green body with gas or liquid prior to pyrolyzation.

34. The method of claim 33, wherein the gas or liquid includes one or more of water vapor, nitrogen, methane, or hydrogen.

35. The method of claim 31, wherein the loose-form adsorbent material includes differing sizes of one or more of powder, grains, sands, or pellets.
